(19) United States
(12) Patent Application Publication
(10) Pub. No.: US 2025/0258509 A1
(43) Pub. Date: Aug. 14, 2025

(54) System for Responsive Daylight Control with a Motorized Window Covering

(71) Applicant: Pradeep Pranjivan Popat, Arlington, VA (US)

(72) Inventor: Pradeep Pranjivan Popat, Arlington, VA (US)

(21) Appl. No.: 18/764,113

(22) Filed: Jul. 3, 2024

Related U.S. Application Data
(60) Provisional application No. 63/596,255, filed on Nov. 4, 2023.
(60) Provisional application No. 63/512,065, filed on Jul. 5, 2023.

(51) Int. Cl. G05D 25/02; E06B 9/28; G01J 1/42; G05B 19/045

(52) U.S. Cl. CPC G05D 25/02; E06B 9/28; G01J 1/42; G05B 19/045; G01J 2001/4266; G05B 2219/2653

(57) ABSTRACT

Disclosed is a system for responsive daylight control using an electronically actuated shading device. Optionally, the system has a longer response time in opening the shading than in closing the shading. Optionally, the system inhibits opening of the shading device in the presence of a fluctuation in the daylight level. Optionally, the response time in opening the shading is increased when the system is powered by a battery and/or with decreasing battery charge.

### CROSS-REFERENCE TO RELATED APPLICATIONS

I hereby claim benefit under Title 35, United States Code, Section 119(e) of U.S. provisional patent application Ser. No. 63/596,255, filed Nov. 4, 2023, and U.S. provisional patent application Ser. No. 63/512,065, filed Jul. 5, 2023, which are currently pending as of the filing of this application.

### PRIOR ART

This disclosure cites the following non-patent prior-art references:
M. Anvari, G. Lohmann, M. Wächter, P. Milan, E. Lorenz, D. Heinemann, M. Reza Rahimi Tabar, and Joachim Peinke (2016). Short term fluctuations of wind and solar power systems. New J. Phys. Volume 18. 063027. https://doi.org/10.1088/1367-2630/18/6/063027.
J. M. Bright, C. J. Smith, P. G. Taylor, R. Crook (2015). Stochastic generation of synthetic minutely irradiance time series derived from mean hourly weather observation data. Solar Energy, Volume 115, 229-242. https://doi.org/10.1016/j.solener.2015.02.032/.
E. S. Lee, D. L. DiBartolomeo, E. L. Vine, Ph. D., and S. E. Selkowitz (1998). Integrated Performance of an Automated Venetian Blind/Electric Lighting System in a Full-Scale Private Office. LBNL-41443, Lawrence Berkeley National Laboratory, California USA.
Mohammed Olama, Jin Dong, Isha Sharma, Yaosuo Xue, and Teja Kuruganti (2020). Frequency Analysis of Solar PV Power to Enable Optimal Building Load Control. Energies 2020, 13, 4593. https://doi.org/10.3390/en13184593

### BACKGROUND OF THE INVENTION

This invention is in the field of automated window-shading systems, and specifically systems employing motorized window coverings and which are capable of automatically controlling admitted daylight in response to changing conditions.

Systems which automatically adjust a window-shading device to one of two fixed settings (e.g. opened and closed), in response to changing conditions, have been available for decades. Such systems include those which provide automatic “open at dawn, close at dusk” operation, and those which automatically close in the presence of direct sunlight (typically sensed as a rise in temperature). Because the adjustments are between only two shading settings, they provide only coarse regulation of the admitted daylight.

A more sophisticated form of automated shading is one which adjusts the shading whenever and as much as necessary to regulate the admitted daylight. Such a capability is referred to herein as responsive daylight control.

It is well-known in the art that responsive daylight control can significantly increase the average level of glare-free natural illumination in indoor spaces when compared to manual control or other forms of automated shading. That, in turn, can provide a healthier and more appealing visual environment, while also increasing the energy savings achievable through daylight-harvesting lighting strategies.

### 1.0 Smart Windows Versus Motorized Window Coverings

Dynamic glazing technologies enable so-called Smart Windows, which offer adjustable shading without moving parts. However, Smart Windows with continuously-variable shading (as needed for responsive daylight control) are not yet cost-effective for mainstream use.

Therefore, motorized window coverings are currently the only viable option for a mainstream responsive daylight-control capability. Window covering amenable to motorization for this purpose include curtains, venetian blinds, and roller shades.

2.0 Obstacles to Responsive Daylight Control with Motorized Window Coverings

Implementing a responsive daylight control system with a motorized window covering presents a dilemma: the system should be responsive enough to quickly block glare and admit useful daylight when there is no risk of glare, and yet it should not respond to rapid fluctuations in solar irradiance (e.g. due to cloud movement) that would otherwise result in frequent high-amplitude shading adjustments.

If the system fails to respond reasonably quickly to significant changes in the daylight level, then the system will provide little benefit over conventional automated shading. On the other hand, if it makes frequent, high-amplitude shading adjustments, its operation will be obtrusive and its mechanical lifetime (and, if battery-powered, its battery life) will be reduced.

The prior art provides no effective solution to this dilemma, which remains a significant obstacle to mainstream deployment of responsive daylight control technology.

### 3.0 Prior-Art Approaches to Overcoming the Obstacles

Practical implementation of responsive daylight control was first addressed at Lawrence Berkeley National Laboratory (LBNL) in the U.S. in the 1990's. Despite being decades old, the techniques developed over the course of that research still represent the current state-of-the-art in overcoming the obstacles described above. A resume of those techniques is given in the referenced 1998 paper by Lee et al at Lawrence Berkeley National Laboratory (LBNL). In general, these techniques fall into two categories: those aimed at reducing the obtrusiveness of shading adjustments, and those aimed at trading-away system responsiveness to minimize the frequency of shading adjustments.

### 3.1 Prior-Art Approaches to Reducing Obtrusiveness of Shading Adjustments

Two approaches have been used to reduce the obtrusiveness of shading adjustments made by responsive daylight control systems that incorporate motorized window coverings: the choice of a motorized horizontal blind as the shading device, and the use of low-duty-cycle pulsed motor operation to make the blind operation less obtrusive.

### 3.1.1. Use of Motorized Horizontal Blind

Horizontal venetian blinds offer two modes of adjustment: adjustable slat tilt and raising/lowering of the slats. The adjustable slat-tilt function is particularly well-suited for responsive daylight control because it provides excellent control of the admitted daylight, can be motorized with a relatively small and quiet motor, and is relatively unobtrusive in operation. No other type of mechanical shading device offers these advantages.

Accordingly, LBNL's prototype responsive daylight-control system employed a horizontal blind with motorized slat-tilt capability.

Even today, the horizontal blind with motorized slat-tilt offers the least obtrusive operation of any cost-effective shading device suitable for responsive daylight control.

### 3.1.2 Use of Low-Duty-Cycle Pulsed Motor Operation

When a motorized blind is actuated via a user interface (e.g. a wireless remote control), users expect shading adjustments to be completed within a few seconds.

On the other hand, while automatic shading adjustments for responsive daylight control should ideally be initiated quickly in response to the onset or cessation of glare-inducing conditions, the adjustments themselves need not be as rapid as for manual adjustments.

This fact can be exploited to reduce the obtrusiveness of automatic adjustments by reducing the motor speed. If a DC gearmotor is used, its speed can be reduced—while still maintaining the required torque—via variable-duty-cycle pulsed operation. The LBNL researchers recognized this in the above-referenced paper (Lee et al, paragraph entitled “Motor”, page 6):
“Because the motor with gear train produced a small, high-pitched sound, modifications were made to reduce both the sound level and the frequency and speed of blind movement. As designed, the miniature high-speed, low-cost DC blind motor was geared down to deliver sufficient torque to operate the blind apparatus. A change in blind angle of about 5° required a DC pulse of approximately 50 ms, which resulted in a quick twist of the blinds which was visually distracting. The motor speed could be reduced by decreasing the supply voltage, and therefore torque, but this would cause the blind to stall under high load conditions (e.g., when closed). Instead, we modulated the duty cycle of the applied DC power to deliver more power when needed to maintain blind movement. A pulsed DC power source at a frequency of ˜100 Hz with a variable duty cycle was used to power the motor for a fixed pulse duration. The rate of blind angle change was reduced by a factor of four while not causing a stall in movement at high loads. In addition, the motor noise was reduced to a soft ticking similar to that of a small clock. Additional noise control can be achieved by placing the motor in a sound-dampening housing.”

Such pulsed operation also offers another advantage for responsive daylight control: it allows time between the pulses for sensor sampling and calculations, e.g. as needed for some approaches to closed-loop daylight control.

### 3.2 Prior-Art Approaches to Trading-Away System Responsiveness

The most straightforward approach to minimizing the obtrusiveness of responsive daylight control is to simply reduce its responsiveness to changing daylight levels, thereby reducing the frequency of shading adjustments. In the above-referenced paper, LBNL researchers state the following (Lee et al, paragraph entitled “System Design”, page 5):
“A very responsive window system may meet all control objectives adequately, especially under transient conditions (partly cloudy skies), but large angle and/or frequent blind movement may cause distraction. Our default setting was activation every 30 s with unlimited blind movement. We parametrically tested a number of algorithms that changed 1) the interval of activation and 2) the amount of change in blind angle within an interval of activation. We also tested “smarter” algorithms that incorporated time delays before a blind could reverse the direction of movement to avoid hunting and oscillations that can occur during partly cloudy conditions.”

Solar irradiance can fluctuate with a period shorter than 30 seconds, so LBNL's choice of a 30-second default activation interval already compromised some control responsiveness for less distracting operation. The other algorithms were aimed at further reducing the system's responsiveness in an attempt to find the optimum balance between responsiveness and unobtrusiveness of operation.

However, Lee at el recognized that the techniques investigated were not always sufficient to achieve an acceptable compromise between responsiveness and unobtrusiveness of operation. In the section titled CONTROL SYSTEM PERFORMANCE, Blind Movement (page 11), they state:
“On occasion, the blind reversed direction or moved significantly within a short period of time in a manner that may be perceived as distracting. With 30-s blind activation, the blind was moved more than 10° total in any direction within 5 min on average 53 times per day (7% of a 12-h day) throughout the year, with a maximum of 234 times occurring on a partly cloudy summer day. The blind reversed direction at least twice within a 2-min period an average of 12 times per day (1.6% of a 12-h day) throughout the year, with a maximum of 70 times occurring also on a partly cloudy day. The tally may be lower than actual because the blind was activated every 30 s while data was recorded every 60 s. Contiguous movement for more than 10 min will result in a higher tally than if non-contiguous.”
“Unnecessary movement can be reduced with smarter control algorithms that accommodate temporary environmental changes. We designed and tested a number of blind algorithms that lengthened the activation cycle, restricted angular movement per activation cycle, and/or delayed angular movement in the opposite direction. In FIG. 9, we compare blind operation on a partly cloudy day if blind movement is not permitted within 15 min of the last time it was moved. In FIG. 10, we compare blind operation if blind movement in the opposite direction is not permitted within 15 min of the last time it was moved. In each case, control objectives were not met as consistently, fluorescent lighting use increased, but movement was reduced which may lessen potential occupant distraction. System longevity may also be increased. Drawbacks include less stability in interior illuminance levels and periodic direct sun. Lighting and cooling energy reductions may also be affected (see energy section below). Design improvements to the blind's motor system over the year resulted in very quiet and smooth motion, which may lessen the importance of these control refinements. User adjustment of blind activation settings may also increase occupant satisfaction.”

In short, by applying the above-described techniques, the LBNL researchers were able to reduce the obtrusiveness of system operation—but not completely, and not without significant compromise in the effectiveness of daylight control provided by the system. In particular, they noted (page 12) that “drawbacks include less stability in interior illuminance levels and periodic direct sun.”

### 3.3 Summary of Prior-Art Limitations

In summary, while decades have passed since LBNL's development of the first responsive daylight control systems, the problem of achieving adequate responsiveness without obtrusive operation remains unsolved. Specifically, prior-art approaches for solving this problem suffer from one of two limitations:
a. excessively long response time to the onset or the cessation of glare-inducing conditions, thereby either exposing building occupants to daylight glare or reducing useful natural illumination (and thereby weakening the value proposition for responsive daylight control); or
b. frequent, high-amplitude shading adjustments, which engender occupant dissatisfaction and reduce system operating lifetime (as well as battery life for battery-powered systems).

These limitations have been a significant factor in the failure of responsive daylight control to gain mainstream commercial acceptance.

### OBJECT OF THE INVENTION

It is therefore an object of the invention disclosed herein to enable a responsive daylight control capability which responds quickly to the onset and cessation of glare-inducing conditions, and yet which avoids excessively frequent shading adjustments.

Further objects and advantages will become apparent from a consideration of the drawings and accompanying description.

### SUMMARY OF THE INVENTION

The subject invention is a system for responsive daylight control using an electronically actuated window-shading device. The system includes a means of obtaining a daylight signal which depends on the daylight level and a controller to open the shading device with decreases in the daylight signal and to close the shading device with increases in the daylight signal. Optionally, the controller has a longer response time in opening the shading than in closing the shading. Optionally, the system includes a means of inhibiting the opening of the shading device in the presence of a fluctuation in the daylight level. Optionally, the response time in opening the shading is increased when the system is powered by a battery and/or with decreasing battery charge.

By optionally having a shorter response time in closing the shading than in opening the shading, the system is able to quickly respond to glare-inducing conditions while still limiting the frequency of shading adjustments. By optionally inhibiting the opening of the shading device during daylight fluctuation, the system can have a shorter response time during periods without daylight fluctuation while still limiting the average frequency of shading adjustments. By optionally increasing the response time in opening the shading when under battery power, and optionally with decreasing battery charge, the system can extend battery lifetime while still providing responsive daylight control.

The system thereby provides a better balance of responsiveness and unobtrusive operation than prior-art approaches to responsive daylight control. Further, it can be implemented through software modifications to conventional daylight-control systems, and is therefore amenable to integration in a wide range of systems capable of automatic daylight control.

### BRIEF DESCRIPTION OF DRAWINGS

FIG. 1 shows a high-level block diagram of an exemplar preferred embodiment of a responsive daylight-control system.

FIG. 2 shows a flowchart of the software operating steps performed by the system of FIG. 1 while the shading is not being adjusted.

FIG. 3 shows a flowchart of a dual-time-constant filter according to the subject invention.

FIG. 4 shows a flowchart of operating steps incorporating the dual-time-constant filter of FIG. 3.

FIG. 5 shows a flowchart of alternative operating steps to implement an asymmetric response time in shading-control logic.

FIG. 6 shows a flowchart of operating steps to indirectly inhibit shade opening in the presence of daylight fluctuation.

FIG. 7 shows a flowchart of operating steps to directly inhibit shade opening in the presence of daylight fluctuation.

FIG. 8 shows a flowchart of a daylight fluctuation detector using broadband amplitude demodulation.

FIG. 9 shows a flowchart of a daylight fluctuation detector using band-limited amplitude demodulation.

FIG. 10 shows a flowchart of a daylight fluctuation detector using band-limited amplitude demodulation via the Goertzel algorithm.

FIG. 11 shows a flowchart of a daylight fluctuation detector implemented using a weather-service Application Programming Interface (API)

FIG. 12 shows a flowchart of operating steps to implement an asymmetric response time and to indirectly inhibit shade opening in the presence of daylight fluctuation.

FIG. 13 shows a flowchart of operating steps to implement an asymmetric response time and to directly inhibit shade opening in the presence of daylight fluctuation.

FIG. 14 shows a block diagram of a responsive daylight-control system with a configurable power source.

FIG. 15 shows a flowchart of operating steps to implement a shade-opening response time dependent on the type power source.

FIG. 16 shows a block diagram of a responsive daylight-control system with a battery power source.

FIG. 17 shows a flowchart of operating steps to implement a shade-opening response time dependent on battery charge.

FIG. 18 is a function block diagram of logic to enable slow-response shade opening in sustained daylight fluctuation.

FIG. 19 is a flowchart of operating steps associated with determining a low-pass filtering time-constant as a function of the presence of fluctuation and the sign of changes in the daylight level.

FIG. 20 shows a functional block diagram of logic to enable a reduced release time after isolated fluctuations.

### DETAILED DESCRIPTION OF THE INVENTION

### 1 Convention Regarding Special Terms and Variables

Italicized but un-bolded text is used herein for the first use of special terms whose meanings are defined in the LIST OF SPECIAL TERMS. Italicized and bolded text are used herein for variables and parameters.

### 2 List of Special Terms

Amplitude demodulator: A means of obtaining an output signal which depends on the amplitude or magnitude of a time-varying input signal.

Closing (of shading device): An adjustment of a window-shading device that tends to increase the shading of the window and, therefore, reduce the daylight admitted by the window.

Daylight level (level of daylight): A quantity which depends on the daylight illuminance on the outward-facing side of a window-shading device, and which-depending on context-could refer either to daylight which is incident on the outward-facing of the shading device, or to daylight which is admitted into a room by the shading device.

Fluctuation (of daylight): A non-monotonic temporal variation of the daylight level.

Fluctuation detection: Detection of ongoing or imminent fluctuation of daylight, either directly by sensing fluctuation in an analog of the daylight level (e.g. the output signal of a daylight sensor), and/or indirectly by sensing conditions correlated with fluctuation (e.g. weather conditions correlated with moving clouds).

Fluctuation spectrum: The frequency content of fluctuation, e.g. as represented by the amplitude-spectral-density, power-spectral-density, or energy-spectral-density of a signal representing the fluctuation.

Non-problematic fluctuation: Fluctuation which can be compensated via automatic adjustment of a shading device without annoyance to building occupants.

Opening (of shading device An adjustment of a window-shading device that tends to decrease the shading of the window and, therefore, increase the daylight admitted by the window.

Opposing-adjustment interval: The interval between shading adjustments in opposite directions (e.g. between closing and opening, or between opening and closing adjustments).

Problematic fluctuation: Fluctuation which, if compensated via automatic adjustment of a shading device, would result in a pattern of shading adjustments which is annoying to building occupants.

Response time (of responsive daylight-control system): In a responsive daylight-control system, the delay between the beginning of a change in the daylight level and the resulting automatic shading adjustment, if any. The shade-closing response time is the interval between the beginning of an increase in the daylight level and the resulting closing of the shading device, while the shade-opening response time is the interval between the beginning of a decrease in the daylight level and the resulting opening of the shading device.

Software: A set of instructions or operations executed by a programmable device (including what is generally referred to as firmware).

### 3 Introduction

To facilitate a complete understanding of the subject invention, this section first addresses requirements for effective responsive daylight control before proceeding to a description of preferred and alternative embodiments.

### 4 Requirements for Responsive Daylight Control

Development of the subject invention was preceded by extensive testing of responsive daylight-control systems using motorized horizontal blinds. The testing confirmed certain long-standing assumptions about occupant-friendly responsive daylight control while contradicting others, and revealed three key requirements (in order of descending importance):
a. The maximum acceptable response time in blocking severe daylight glare is only a few seconds.
b. The minimum acceptable interval between shading adjustments in opposite directions (hereinafter referred to as the minimum acceptable opposing-adjustment interval) is much longer (typically at least several minutes and often more than ten minutes, depending on the occupant). On the other hand, there is little correlation between occupant satisfaction and the minimum interval between shading adjustments in the same direction.
c. Subject to the above constraint, the system should be as responsive as possible to falling daylight levels. This is because, while a long delay between the cessation of glare-inducing conditions and opening of the shading will not distract or annoy occupants, it will decrease both the actual and perceived benefit of responsive daylight control.

The subject invention enables these requirements to be met to a greater degree than is possible with conventional responsive daylight control systems.

### 5 Overview of Subject Invention

The subject invention, informed by the results of the testing described above, incorporates one or both of two innovations in the form of algorithms implemented with conventional daylight-control hardware:
a. An asymmetric response time to changing daylight levels, such that the system reacts more quickly to close the shading in rising daylight levels than to open the shading in falling daylight levels. Optionally, the response time to falling daylight levels is increased when the system is operating under battery power and/or as the battery charge is depleted, in order to maximize battery life.
b. Inhibition of shade-opening adjustments during problematic daylight fluctuation.

When implemented alone, each of these innovations enables significantly higher levels of occupant satisfaction than when the same hardware is used to implement conventional responsive daylight-control algorithms. The innovations are complementary, such that combining them leads to still further increases in occupant satisfaction.

Each of the innovations (and combinations thereof) offers a different balance of simplicity and effectiveness, and might therefore be preferred over the others in a particular application.

### 6 Overview of Disclosure

Since the subject invention can be implemented with conventional responsive daylight-control hardware, this disclosure begins with a high-level description of a responsive daylight-control system that applies to conventional systems as well as to preferred embodiments of the subject invention. Preferred embodiments of the subject invention are then described as modifications to, or lower-level details of, the initially-described high-level configuration.

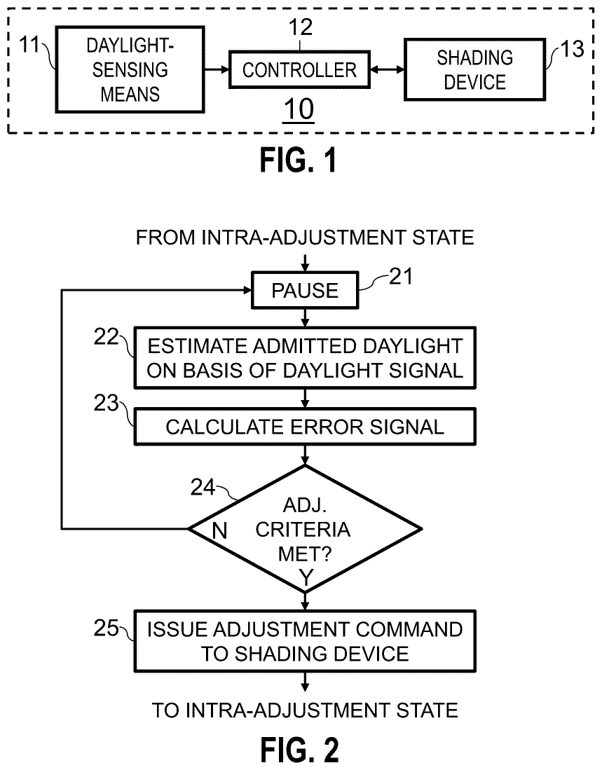

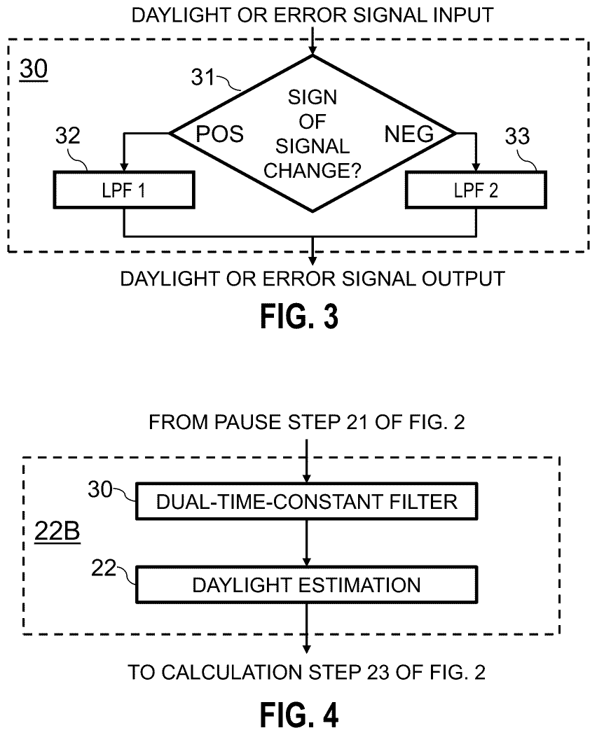

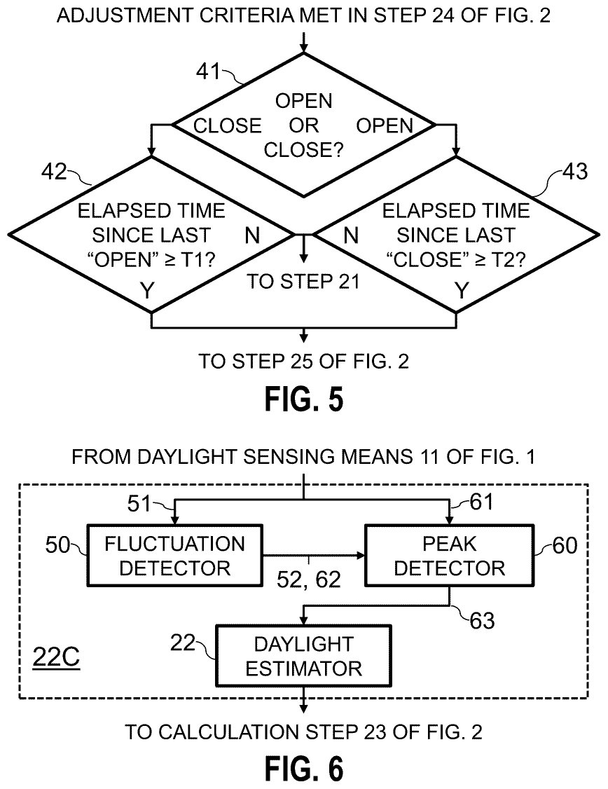

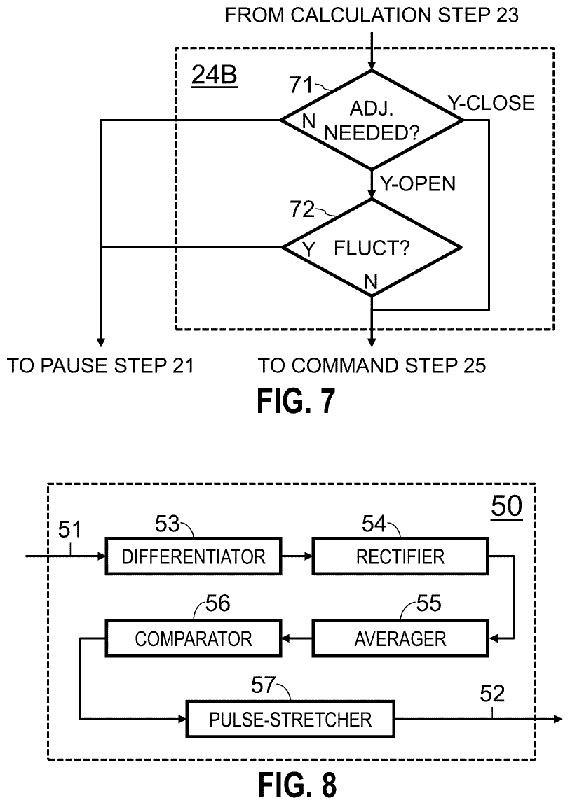

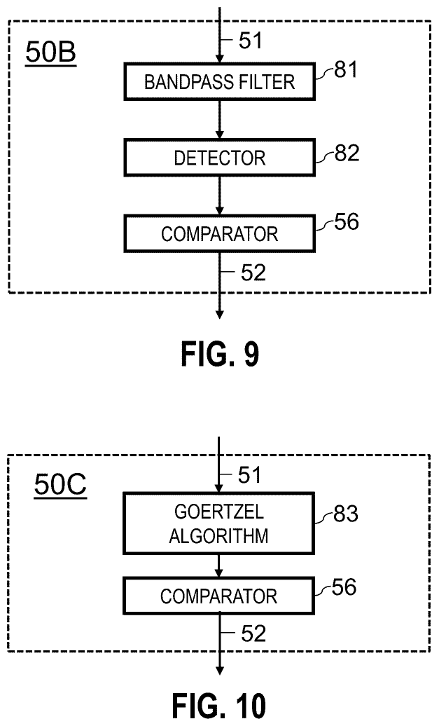

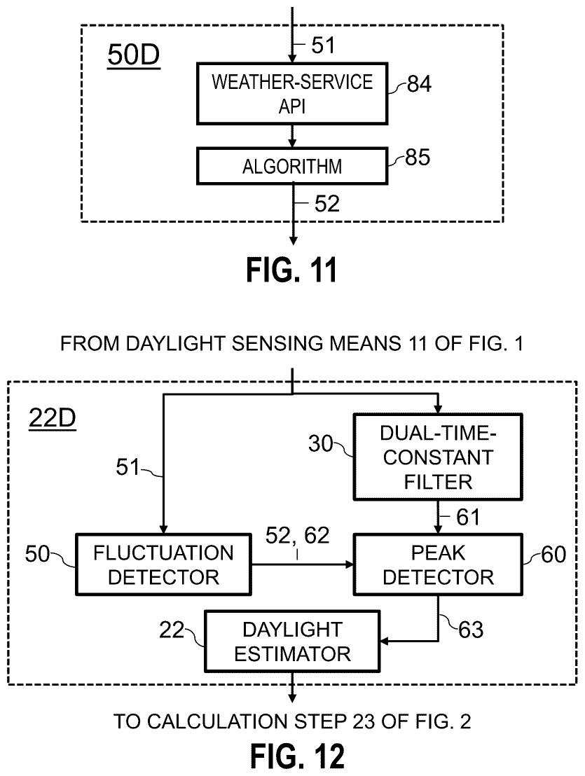

### 7 FIG. 1: High-Level Block Diagram of Responsive Daylight-Control System

FIG. 1 depicts a high-level block diagram of a responsive daylight-control system 10 according to the subject invention. At this high level, the block diagram shown in FIG. 1 is also representative of conventional responsive-daylight-control systems.

System 10 includes conventional daylight-sensing means 11, a conventional controller 12, and a conventional electronically actuated window-shading device 13. Shading device 13 is mounted on a window in a room (not shown). The purpose of system 10 is to automatically actuate shading device 13 to regulate the daylight admitted by shading device 13 into the room.

As with conventional responsive daylight-control systems, system 10 will typically include other conventional elements such as those required to implement a power supply or a user-system interface. Such conventional elements are incidental to responsive daylight-control in general, as well as to the embodiments of the subject invention to be described in reference to FIG. 1, and are omitted for the sake of clarity.

As with conventional responsive daylight-controls systems, the elements of FIG. 1 need not be physically collocated. For example, shading device 13 can be attached to a window in a room, sensing means 11 can be mounted on the roof the building containing the room, and controller 12 could be “in the cloud”, i.e. in a remote server. Conversely, all of the elements of FIG. 1 can be physically collocated in a single package, e.g. attached to a window.

### 7.1 Daylight-Sensing Means 11

Daylight-sensing means 11 is a conventional means of producing a daylight signal which depends, directly or indirectly, on the daylight illuminance on the outside of the window on which shading device 13 is mounted. Such means could be, for example, an electro-optical sensor sensitive to a wavelength in the daylight spectrum (whether visible or invisible), a temperature sensor, a current sensor to monitor the output current of a photovoltaic panel, or an interface to obtain a daylight signal from an external source. In the preferred embodiment, daylight-sensing means 11 is a light-sensing integrated circuit which incorporates a photodiode, an analog-to-digital converter, and a serial interface to produce the daylight signal in digital form.

Daylight-sensing means 11 can be used in two ways, depending on how it is positioned relative to shading device 13:
a. It can be positioned on the inward-facing-side of shading device 13 to sense the daylight admitted by shading device 13, thereby enabling closed-loop daylight control.
b. It can be positioned on the outward-facing side of shading device 13, thereby enabling open-loop daylight control.

In the former case, the daylight signal produced by means 11 depends indirectly on the external daylight illuminance (as modulated by shading device 13), while in the latter case the daylight signal produced by means 11 depends directly on the external daylight illuminance (in the case of a visible-wavelength electro-optical sensor) or indirectly on the external illuminance (in the case of a non-visible-wavelength or temperature sensor).

### 7.2 Controller 12

Controller 12 is a conventional device that implements a control algorithm to regulate the daylight admitted by shading device 13. It includes a processor executing software steps (and which will typically also perform other tasks in addition to responsive daylight control).

When performing responsive daylight control, controller 12 accepts the daylight signal from daylight-sensing means 11, processes it according to the control algorithm, and therefrom produces a control signal to actuate shading device 13.

Controller 12 will operate in one of two operating states when performing responsive daylight control (in addition to other conventional states, such as a system power-up state):
a. In an inter-adjustment state, which is the default state while the system is performing responsive daylight control, the controller will periodically evaluate the need for a shading adjustment. If an adjustment is needed, the controller will issue a command to shading device 13 to initiate a shading adjustment, at which point the system will enter an intra-adjustment state.
b. In the intra-adjustment state, the system will attempt to adjust the shading to a setting calculated to result in the desired level of admitted daylight (for open-loop control), or until the daylight signal corresponds to the desired level of admitted daylight (for closed-loop control). After the adjustment is complete, the system will re-enter the inter-adjustment state.

The system's behavior in the intra-adjustment state is incidental to the subject invention, while its behavior in the inter-adjustment state is what determines its responsiveness to changing daylight levels and is the focus of the subject invention.

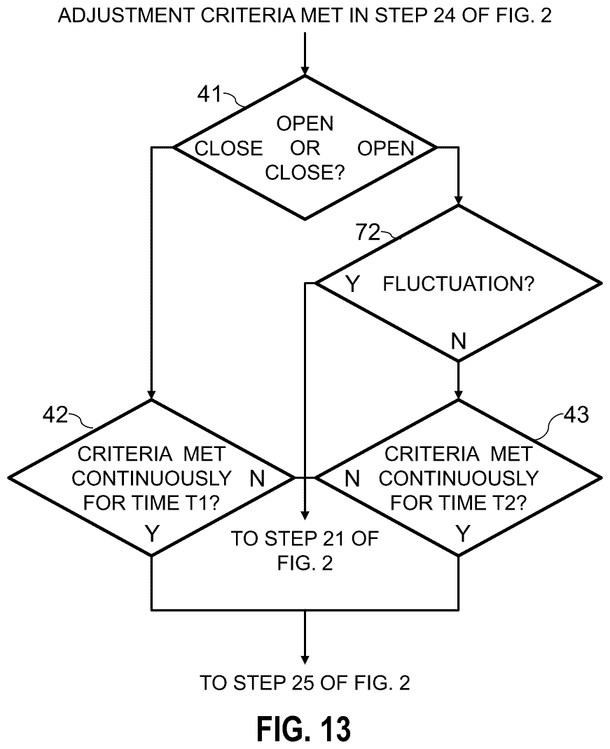

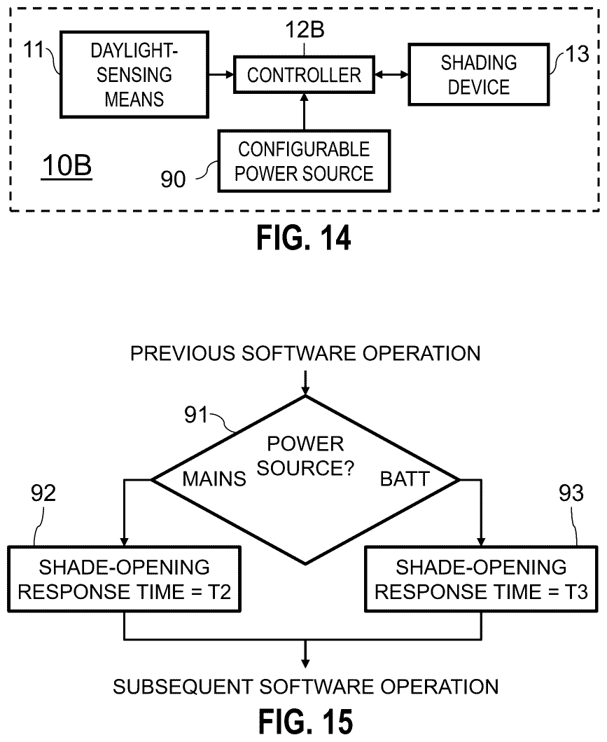

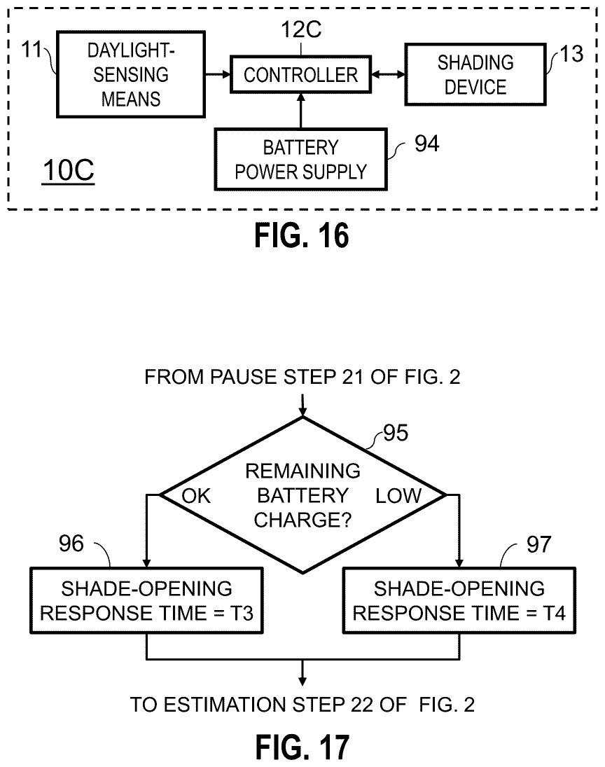

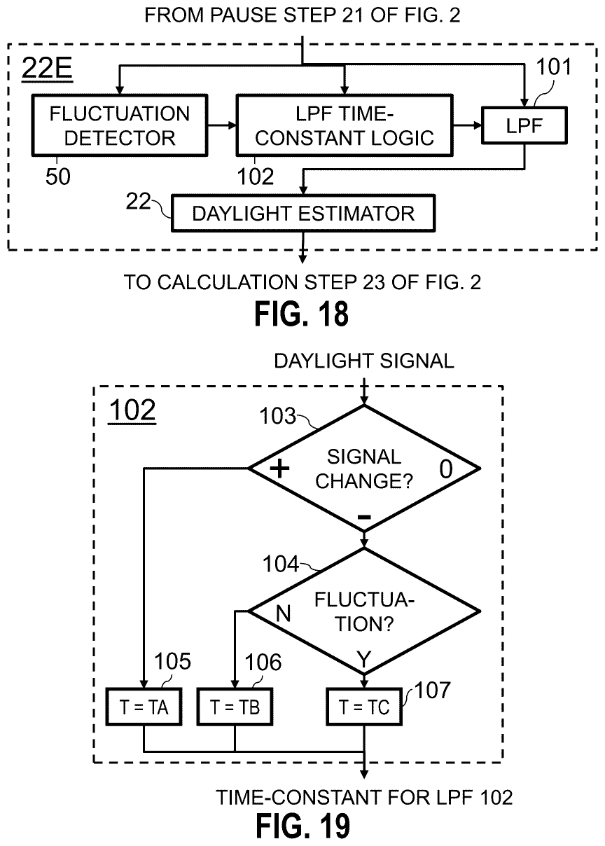

### 7.2.1 FIG. 2: High-Level Flowchart of Inter-Adjustment State

FIG. 2 shows a flowchart of the inter-adjustment state of the control algorithm executed by controller 12. At this high level, the flowchart shown in FIG. 1 is also representative of the inter-adjustments steps performed by conventional responsive-daylight-control systems.

The operations performed in the inter-adjustment state include a loop over five steps:
a. In a pause step 21, loop execution is paused for an interval that determines the loop frequency.
b. In an estimation step 22, the daylight level admitted by shading device 13 is estimated on the basis of the daylight signal from daylight sensing means 11. If the system is performing closed-loop control, then the daylight signal already represents the admitted daylight. However, if the system is performing open-loop control, then the daylight signal represents the daylight on the outward-facing side of the shading device. In that case, the system estimates the admitted daylight level as a function of the daylight signal and the shading setting of shading device 13 (and optionally other variables), according to an assumed transfer function.
c. In a calculation step 23, the system subtracts a daylight set-point (representing the desired level of admitted daylight) from the estimate of the admitted daylight obtained in step 22 to obtain an error signal. The error signal is positive when the admitted daylight is greater than the set-point, and negative if the admitted daylight is less than the set-point.
d. In a decision step 24, the system decides whether a shading adjustment is needed. At least two criteria must be met for the system to decide that a shading adjustment is needed: the error signal obtained in step 23 must fall outside a predetermined range (i.e. a deadband), and shading device 13 must not already be at the limit of its adjustment range in the intended direction. Optionally, the system can also require that additional criteria be met before deciding that a shading adjustment is needed.
e. If in step 24 the system decides that no shading adjustment is needed, pause step 21 is repeated. Otherwise, in a command step 25, a shading adjustment command is issued to shading device 13. If the error signal is positive, a “close” command is issued to cause the shading to increase in order to decrease the admitted daylight; if the error signal is negative, an “open” command is issued to cause the shading to decrease in order to increase the admitted daylight.
f. After command step 25, the system enters the intra-adjustment state until the shading adjustment is completed, after which the system re-enters the inter-adjustment state via pause step 21.

As noted above, the pause interval implemented in pause step 21 determines the loop execution frequency and, thus, the system's maximum bandwidth and minimum response time.

### 7.2.2 Intra-Adjustment State

The operation of system 10 in the intra-adjustment state is conventional and incidental to the subject invention. However, the following description is provided for the sake of completeness.

In the intra-adjustment state, controller 12 executes the same steps of FIG. 2 with three modifications:
a. The pause interval of step 21 is set to zero so that the control loop executes more frequently.
b. Decision step 24 evaluates criteria to stop the ongoing shading adjustment (rather than to start an adjustment). Specifically, in decision step 24, a decision to stop the ongoing shading adjustment is made if either (1) the error signal calculated in step 23 has dropped to an acceptably low value (e.g. zero), or (2) if shading device 13 has reached the limit of its adjustment range.
c. In command step 25, a command is issued to stop (rather than start) the shading adjustment.

### 7.3 Electronically-Actuated Shading Device 13

Electronically-actuated shading device 13 is a conventional device that provides variable shading in response to commands from controller 12. Specifically, shading device 13 provides an increase in shading (to reduce admitted daylight) upon receipt of a “close” command from controller 12, a decrease in shading (to increase the admitted daylight) upon receipt of an “open” command from controller 12, and cessation of an ongoing shading adjustment upon receipt of a “stop” command from controller 12. A wide variety of shading devices can be used as shading device 13, including Smart Windows and motorized window coverings such as curtains, blinds, and shades.

Ideally, shading device 13 would be a Smart Window with no moving parts and with a continuously-variable visible transmittance which can be instantly adjusted over a wide range. Unfortunately, such Smart Windows are not yet cost-effective for mainstream use, so in the near-term, shading device 13 will most likely be a motorized window covering.

Among current motorized window coverings, the most advantageous for responsive daylight control is the horizontal blind with motorized slat-tilt function. Such motorized blinds provide relatively unobtrusive, granular daylight control at relatively low cost, and are therefore currently the preferred implementation of shading device 13.

### 7.3.1 Convention Regarding Slat Tilt Angles

A horizontal blind provides minimum shading when its slats are tilted to a near-horizontal angle; the shading increases as the slats are tilted in either direction away from the horizontal. Thus, when shading device 13 is a horizontal blind with a motorized slat-tilt function, “opening the shading” refers to tilting of the slats toward a horizontal angle, while “closing the shading” refers to tilting of the slats in either direction away from the horizontal.

However, as is well-known in the art, horizontal blinds provide better control of direct sunlight when the slats are tilted so the inside-facing edges are higher than the outside-facing edges. Accordingly, when shading device 13 is a horizontal blind, it will advantageously be operated so that its slats are tilted between a near-horizontal angle (for the “open” position) and a near-vertical angle at which their inside-facing edges are above the outside-facing edges (for the “closed” position).

### 7.4 Other Aspects of System 10 Incidental to Responsive Daylight Control

A responsive daylight-control system will typically include other conventional hardware elements, and execute other software operations, in addition to those described above in reference to FIGS. 1 and 2. Such conventional elements and operations include those associated with implementing a power supply, a user-system interface, an interface to other systems, remote-control functionality, a capability for automatic scheduled shading adjustments, or a system set-up and commissioning process. Such conventional elements and operations are incidental to responsive daylight-control in general (and the subject invention in particular), and are omitted for the sake of clarity.

### 8 Preferred Embodiments with Asymmetric Response Times

Referring again to FIGS. 1 and 2, the response time of system 10 can be defined as the delay between (a) the beginning of a change in the daylight level which will eventually be large enough to require a shading adjustment (per calculation step 23 and decision step 24 of FIG. 2), and (b) the beginning of the resulting automatic adjustment of shading device 13 of FIG. 1.

Since the response time is defined from the beginning of the change in the daylight level, the response time depends on both the characteristics of system 10 and the rate of change of the daylight level. The characteristics of system 10 which determine the response time include:
a. The interval between successive iterations of steps 21 through 24 of FIG. 2, which is determined by the pause interval implemented in pause step 21.
b. The criteria for making a shading adjustment evaluated in decision step 24, and specifically the allowable magnitude of the error signal calculated in calculation step 23 before a shading adjustment is initiated (i.e. the system deadband).
c. Any low-pass filtering or delays implemented in any of the steps of FIG. 2 (as will be discussed subsequently).

Thus, the minimum response time of system 10 is determined by the pause interval implemented in pause step 21 of FIG. 2. As previously noted, the maximum acceptable response time in blocking severe daylight glare is only a few seconds, so the pause interval implemented in pause step 21 should ideally be no longer than a few seconds. However, absent other measures that will be subsequently described, a response time of only a few seconds will result in excessively frequent shading adjustments.

A conventional approach to mitigating this problem is to sacrifice responsiveness by increasing the response time by increasing the pause interval. For example, Lee et al refer to this pause interval as the “activation interval”, and cite a default value of 30 seconds in order to limit distracting operation.

However, testing of the subject invention confirms that a response time of 30 seconds results in an unacceptably slow response to daylight glare, and yet still does not sufficiently decrease the frequency of shading adjustments in fluctuating daylight levels.

To overcome this, certain embodiments of the subject invention implement two different response times: one for opening the shading, and one for closing the shading. Such an asymmetric response time can implemented in at least several ways:
a. Filtering can be implemented in the daylight signal chain such that a falling daylight level experiences a longer delay than a rising daylight level.
b. The logic used to actuate shading device 13 can be modified so that the criteria for making a shading adjustment must be met for a certain minimum interval before the adjustment is made, such that the criteria for opening the shading must be met for a longer interval than the criteria for closing the shading.
c. The logic used to actuate shading device 13 can be modified so that a certain minimum interval must elapse between successive shading adjustments in the same direction, such that the minimum interval between shade-opening adjustments is longer than the minimum interval between shade-closing adjustments.
d. An asymmetric deadband can be used, such that the magnitude of the error (i.e. the difference between the estimated and actual daylight levels) must be greater to trigger a shade-opening adjustment than to trigger a shade-closing adjustment.
   8.1 Preferred Embodiment with Asymmetric Response Time Implemented in Daylight Signal Chain

An asymmetric response time can be achieved by inserting a dual-time-constant low-pass filter in the daylight signal chain. Referring again to FIG. 1, if daylight-sensing means 11 were an analog device, this could be implemented as an analog filter, with separate time-constants for rising and falling signal levels, inserted between sensing means 11 and controller 12.

However, in the preferred embodiment, daylight-sensing means 11 has a digital output, and the dual-time-constant low-pass filter is most advantageously implemented via software operations between pause step 21 and decision step 24 of FIG. 2.

### 8.1.1 FIG. 3: Flowchart of Dual-Time-Constant Filter

FIG. 3 shows a flowchart of such a dual-time-constant low-pass filter 30. Filter 30 has an input and output, and includes the following:
a. In a decision step 31, operation branches depending on the sign of the change in the input. The sign of the change is determined by storing the input signal level between loop executions and subtracting the current level from the previous level.
b. If decision step 31 determines that the input signal has increased, operation branches to an optional low-pass filtering step 32 which applies a low-pass filter LPF 1 to the input signal. This is conveniently implemented as a conventional Exponentially-Weighted Moving Average (EWMA), in which the filter output is equal to a weighted sum of the current and previous input values. Because LPF 1 is optional (as described below), it can be omitted, in which case, step 32 can simply pass the input signal unchanged.
c. However, if decision step 31 determines that the input signal has decreased, operation branches to a low-pass filtering step 33 which apples a low-pass filter LPF 2 to the input signal. This is also conveniently implemented as an EWMA.
d. The output of filter 30 is then the sum of the outputs of steps 32 and 33.

The time-constant of LPF 2 of step 33 is chosen to be longer than that of optional LPF 1 of step 32, so that falling daylight levels are smoothed more (and thereby delayed more) than are rising daylight levels. A time-constant of, e.g., a few seconds is appropriate for LPF 1, while a time-constant of, e.g., a few minutes or longer is appropriate for LPF 2.

LPF 1 may not be necessary unless the pause interval in pause step 21 of FIG. 2 is much shorter than a few seconds. This might be the case if a high loop frequency is desired to sense the presence of high-frequency daylight fluctuations (as is the case with other embodiments described herein). Otherwise, the pause interval in step 21 of FIG. 2 can be set to the desired response time for rising daylight levels (e.g. a few seconds), and LPF 1 can be omitted.

Referring again to FIG. 2, the steps associated with filter 30 can be inserted in the signal chain anywhere between pause step 21 and decision step 24. For example:
a. The steps can be inserted between pause step 21 and estimation step 22, in which case the input of filter 30 is the signal from daylight-sensing means 11 of FIG. 1, and the output of filter 30 is a filtered (and hence delayed) version of that signal.
b. The steps can be inserted between estimation step 22 and calculation step 23, in which case the input of filter 30 is the daylight level estimated in step 22, and the output of filter 30 is a filtered (and hence delayed) version of the estimated daylight level.
c. The steps can be inserted between calculation step 23 and decision step 24, in which case the input of filter 30 is the error in step 23, and the output of filter 30 is a filtered (and hence delayed) version of the error.
   8.1.2 FIG. 4: Flowchart of Daylight-Estimation Step with Dual-Time-Constant Filter

In an exemplar preferred embodiment, the steps to implement dual-time-constant filter 30 are performed in a daylight estimation step 22B, shown in FIG. 4, which is performed in lieu of estimation step 22 of FIG. 2. The dual-time-constant low-pass filtering is thus applied before daylight estimation, so that the system effectively operates on the basis of the filtered (vice actual) daylight level.

8.2 FIG. 5: Preferred Embodiment with Asymmetric Response Time Implemented in Shading-Control Logic

Instead of dual-time-constant low-pass filtering in the signal chain (per dual-time-constant filter 30 of FIG. 3), an asymmetric response time according to the subject invention can alternatively be implemented in the control logic used to make shading adjustments.

FIG. 5 shows how this can be implemented as software steps which are performed between decision steps 24 and command steps 25 of FIG. 2.

These steps begin with a decision step 41 in which operation branches depending on whether the decision made in step 24 was to increase (close) or decrease (open) the shading:
a. If the decision was to close the shading, operation branches to an optional decision step 42. Decision step 42 branches to pause step 21 of FIG. 2 unless an interval of at least T1 has elapsed since the previous shade-opening adjustment. In that case, operation branches to command step 25 of FIG. 2 to issue a command to begin closing the shading. Thus, shade-closing is delayed by T1 following any shade-opening adjustment, but thereafter multiple shade-closing adjustments can be made consecutively without incurring the delay.
b. If the decision was to open the shading, operation branches to a decision step 43. Decision step 43 branches to pause step 21 of FIG. 2 unless an interval of at least T2 has elapsed since the previous shade-closing adjustment. In that case, operation branches to command step 25 of FIG. 2 to issue a command to begin opening the shading. Thus, shade-opening is delayed by T2 following any shade-closing adjustment, but thereafter multiple shade-opening adjustments can be made consecutively without incurring the delay.

Interval T2 of step 43 is chosen to be longer than interval T1 of step 42, so there is a longer delay in opening the shading after a shade-closing adjustment than in closing the shading after a shade-opening adjustment. An interval of the order of a few seconds is appropriate for T1, while an interval of the order of a few minutes is appropriate for T2.

Optional decision step 42 is necessary only if the pause interval in pause step 21 of FIG. 2 is shorter than a few seconds. This might be the case if a high loop frequency is desired to sense the presence of high-frequency daylight fluctuations. Otherwise, the pause interval in step 21 of FIG. 2 can be set to the desired response time for closing the shading (e.g. a few seconds) and interval T1 can be made equal to zero, such that step 42 can be omitted.

Thus, when the steps of FIG. 4 are implemented in addition to the steps of FIG. 2, system 10 of FIG. 1 has an asymmetric response time with a longer response time in opening the shading (in response to dropping daylight levels) than to closing the shading (in response to rising daylight levels).

Note that the response times due to intervals T1 and T2 apply only to reversals in the direction of shading adjustment. Specifically, interval T1 applies only to the first shade-closing adjustment after a shade-opening adjustment, while interval T2 applies only to the first shade-opening adjustment after a shade-closing adjustment; no delay is required between subsequent adjustments in the same direction.

When compared to the dual-time-constant filter 30 of FIGS. 3 and 4 (in which the response time applies to every shading adjustment), the implementation of FIG. 5 reduces the frequency of shading adjustments while increasing the average magnitude of the adjustments. Many building occupants prefer this behavior.

If this is not the case, the implementation shown in FIG. 5 can be modified to impose delays on every shading adjustment, as follows:
a. In decision step 42, the criterion to proceed to step 25 is changed from “ELAPSED TIME SINCE LAST OPEN≥T1?” to “ELAPSED TIME SINCE LAST SHADING ADJUSTMENT≥T1?”
b. In decision step 43, the criterion to proceed to step 25 is changed from “ELAPSED TIME SINCE LAST CLOSE≥T2?” to “ELAPSED TIME SINCE LAST SHADING ADJUSTMENT≥T2?”

This modification results in behavior similar to that provided by dual-time-constant filter 30 of FIGS. 3 and 4.

8.3 Preferred Embodiment with Asymmetric Response Time Implemented Via Asymmetric Deadband

As previously described in reference to FIG. 2, system 10 makes a shading adjustment only if decision step 24 determines that the error signal calculated in calculation step 23 falls outside a predetermined range (i.e. the deadband). The deadband determines the precision of system 10 in controlling the admitted daylight and the system's sensitivity to changes in the daylight level.

Conventionally, the deadband is chosen to be as large as possible (to minimize the frequency of shading adjustments), while still providing the required precision of daylight control.

Increasing the deadband will make the system less sensitive to daylight changes while also increasing the response times of system 10 to gradual changes in the daylight level. Further, making the deadband asymmetric will yield a different response time for shade-opening than for shade-closing in response to gradual changes in the daylight level. This can be implemented by including the following logic in decision step 24 of FIG. 2:
a. If the error signal is greater than a positive Close threshold, software operation branches to command step 25 to close the shading; otherwise, operation branches to pause step 21.
b. If the error signal is less than a negative Open threshold, software operation branches to command step 25 to open the shading; otherwise, operation branches to pause step 21.

If the magnitude of the Open threshold is made greater than that of the Close threshold, the deadband will be asymmetric, and the system will have a longer shade-opening response time than a shade-closing response time for gradual changes in the daylight level. This can reduce the average frequency of shading adjustments without sacrificing responsiveness to increasing daylight levels.

However, increasing the magnitude of the Open threshold will not significantly increase the shade-opening response time to rapid, high-amplitude decreases in the daylight level.

8.4 Advantages and Limitations of Embodiments with Asymmetric Response Time

Implementation of an asymmetric response time as previously described enables system 10 of FIG. 1 to respond quickly to block glare while still limiting the peak frequency of shading adjustments. Testing shows that this behavior results in substantially greater occupant satisfaction than just increasing the response time symmetrically per conventional approaches.

However, the testing also shows that an asymmetric response time per se does have two limitations:
a. The delay in opening the shading is longer than necessary when there is little or no problematic daylight fluctuation. Such a situation can occur, for example, when the solar disc passes behind terrain or buildings: there is no sustained daylight fluctuation, so the shading should ideally be opened quickly.
b. When the fluctuation period is comparable to the sum of the shade-opening and shade-closing response times, the delay in shade-opening can cause the shading to open just as the daylight level begins to rise again, which in turn triggers an almost immediate shade-closing adjustment. This opening-then-immediate-closing behavior is annoying to building occupants, and especially so in sustained fluctuation when such a pattern of opening-then-immediate-closing adjustments can occur every few minutes (depending on the response times). Unfortunately, simply increasing the shade-closing response time is not a viable approach to increasing the interval between the opening and closing adjustments, because the system must remain capable of responding quickly to block glare.

### 9 Preferred Embodiments which Inhibit Shade-Opening Adjustments in Daylight Fluctuation

Another way of implementing an asymmetric response time is to inhibit shade-opening adjustments during problematic fluctuation while still performing shade-closing adjustments. This effectively increases the shade-opening response time to equal the duration of the problematic fluctuation, but only during the problematic fluctuation.

This requires a means of detecting or inferring problematic daylight fluctuation, and either:
a. a means of directly suspending adjustments to reduce the shading when problematic fluctuation is detected, or
b. a means of indirectly suspending adjustments to reduce the shading by making shading adjustments on the basis of the maximum (and not instantaneous) value of the daylight level during problematic fluctuation.

Both approaches have proven equally advantageous from a performance standpoint, but one may be simpler to implement than the other depending on how other aspects of system 10 are implemented.

To facilitate a complete understanding of this aspect of the subject invention, the following description includes three sections:
a. a description of a preferred embodiment which indirectly suspends shade-opening adjustments in problematic daylight fluctuation;
b. a description of a preferred embodiment which directly suspends shade-opening adjustments in problematic daylight fluctuation; and
c. a description of a preferred embodiment (and alternatives thereto) of means for detecting or inferring the presence of problematic daylight fluctuation, for use in the previously-described embodiments.
   9.1 FIG. 6: Preferred Embodiment with Indirect Inhibition of Shade Opening in Daylight Fluctuation

System 10 of FIG. 1 can be modified to indirectly inhibit shade-opening adjustments during daylight fluctuation by modifying estimation step 22 of FIG. 2 as described below.

FIG. 6 is a flowchart of such a modified estimation step, an estimation step 22C. Step 22C is identical to step 22 of FIG. 2, except that the daylight estimation is preceded by software operations to implement two functional blocks: a fluctuation detector 50 and a peak detector 60.

Fluctuation detector 50 detects problematic patterns of daylight fluctuation, and will be described in detail in a subsequent section of this disclosure. It accepts an input 51 and has an output 52; it produces a “fluctuation” signal on output 52 when the signal on input 51 meets certain criteria.

Peak detector 60 has a signal input 61, a control input 62, and a signal output 63. Peak detector 60 includes conventional software operations to:
a. store the maximum value of a signal on signal input 61, and pass that maximum value to signal output 63, while a “fluctuation” signal is registered on control input 62; and
b. pass the signal on signal input 61 unchanged to output 63 while a “fluctuation” signal is not registered on control input 62.

Input 51 of fluctuation detector 50 and input 61 of peak detector 60 are interconnected, and both receive the output of daylight sensing means 11 of FIG. 1. Thus, fluctuations in the daylight signal used for responsive daylight control (i.e. the signal which passes through peak detector 60) are sensed by fluctuation detector 50.

Output 52 of fluctuation detector 50 is connected to control input 62 of peak detector 60, so that the “fluctuation” signal produced by the former determines whether the latter passes the peak value or the unchanged value of the daylight signal to signal output 63.

Thus, when estimation step 22 of FIG. 2 is replaced by estimation step 22C of FIG. 6, system 10 of FIG. 1 adjusts shading device 13 on the basis of the sensed daylight level when there is no daylight fluctuation, but on the basis of the peak of the sensed daylight level during daylight fluctuation. In this way, the system is able to respond quickly to rising daylight levels, while at the same time avoiding excessively frequent shading adjustments during daylight fluctuation.

9.1.1 Alternative Embodiments with Indirect Inhibition of Shade Opening in Daylight Fluctuation

In the embodiment described above (and as shown in FIG. 6), fluctuation detector 50 and peak detector 60 are implemented in estimation step 22C, which is performed in lieu of step 22 of FIG. 2. However, peak detector 60 could instead be incorporated in calculation step 23, or in fact at any point in the signal chain before decision step 24.

Also, while FIG. 6 shows that the inputs of both fluctuation detector 50 and peak detector 51 are connected to the output of daylight sensing means 11 of FIG. 1, the inputs need not be the same. For example, input 51 of fluctuation detector 50 could remain connected to the output of daylight-sensing means 11, while input 61 of peak detector 60 could instead be driven by the error signal produced in calculation step 23 of FIG. 2. The only requirement is that input 51 of fluctuation detector 50 must be connected upstream of any fluctuation suppression (e.g. as provided by peak detector 60 or any low-pass filtering in the signal chain).

9.2 FIG. 7: Preferred Embodiment with Direct Inhibition of Shade Opening in Daylight Fluctuation

Instead of inhibiting decreases in the sensed daylight level (and thereby indirectly inhibiting shade opening), the fluctuation signal produced by fluctuation detector 50 can instead be used to directly inhibit shade-opening adjustments. This can be done by adding a test for the presence of the “fluctuation” signal produced by detector 50 to the criteria for shade opening in decision step 24 of FIG. 2.

FIG. 7 shows such a decision step 24B which, when performed in lieu of decision step 24 of FIG. 2, will directly inhibit adjustments to open the shading when the “fluctuation” signal is asserted. As with the embodiment described in reference to FIG. 6, in this embodiment, fluctuation detector 50 is implemented via software operations performed by controller 12 of FIG. 1, and will be described in detail subsequently.

Decision step 24B includes the following steps:
a. A decision step 71 determines whether the error signal produced by calculation step 23 of FIG. 2 meets criteria to close or open the shading. If decision step 71 determines that the magnitude of the error signal is small enough that no shading adjustment is needed, operation branches to pause step 21 of FIG. 2.
b. If decision step 71 determines that the error signal is high enough to warrant closing the shading, then operation branches to command step 25, which issues a command to close the shading.
c. On the other hand, if decision step 71 determines that the error signal is low enough to warrant opening the shading, then operation branches to a decision step 72.
d. Decision step 72 checks for the presence of fluctuation by checking whether the “fluctuation” signal is being asserted by fluctuation detector 50 (not shown in FIG. 7). If there is fluctuation, operation branches to pause step 21 of FIG. 2.
e. On the other hand, if decision step 72 determines that there is no fluctuation, then operation branches to command step 25, which issues a command to open the shading.

Thus, when system 10 of FIG. 1 implements decision step 24B of FIG. 7 instead of decision step 24 of FIG. 2, it will inhibit shade-opening adjustments in the presence of daylight fluctuation, but will open the shading normally when there is no daylight fluctuation.

### 9.3 Fluctuation Detector 50

The purpose of fluctuation detector 50 is to detect the current or imminent presence of problematic fluctuation as reliably and as quickly as practicable.

### 9.3.1 Problematic Fluctuation Versus Non-Problematic Fluctuation

As previously stated, the primary cause of occupant annoyance with responsive daylight control is a pattern of shading adjustments in which the interval between opposing adjustments is less than a few minutes (and sometimes less than ten minutes or more, depending on the occupant). Fluctuation which would tend to cause such a pattern of shading adjustments is considered herein to be problematic fluctuation. Problematic fluctuation appears to be caused solely by intermittent shading of the solar disc by moving clouds.

Conversely, fluctuation which can be compensated without such a pattern of frequent shading adjustments in opposite directions is considered herein to be non-problematic fluctuation. Non-problematic fluctuation is characterized by gradual changes in the daylight level over periods of at least ten minutes (e.g. due to changes in the solar angle of incidence caused by the earth's rotation), as well as to infrequent isolated changes in the daylight level over periods as short as a few seconds (e.g. due to obscuration of the solar disc by terrain or buildings, again caused by the earth's rotation).

### 9.3.2 Approaches for Detecting Problematic Fluctuation

Since problematic fluctuation appears to be caused by moving clouds, it can be detected indirectly via weather information. Alternatively, it can be detected directly via fluctuations in the daylight irradiance, on the basis of the distinguishing characteristics described briefly above (and in more detail below). Fluctuation detector 50 can exploit either approach.

However, direct detection via irradiance fluctuation is generally less expensive and easier to implement in systems that do not already have a means of obtaining weather information, particularly because a responsive daylight-control system will necessarily already include a means of sensing daylight irradiance (e.g. sensing means 11 of FIG. 1). Accordingly, the following description of fluctuation detector 50 begins with embodiments which use direct detection.

### 9.3.3 Direct Detection of Problematic Fluctuation

A practical way of distinguishing problematic fluctuation from non-problematic fluctuation is via characteristics of the fluctuation spectrum, i.e. the frequency content of the fluctuation (e.g. as represented by the amplitude-spectral-density, power-spectral-density, or energy-spectral-density of a signal representing the fluctuation).

However, the frequency ranges associated with problematic and non-problematic fluctuation are subjective (inasmuch as they depend on occupants' reaction to frequent shading adjustments), and are therefore best expressed in terms of approximate order-of-magnitude frequency bounds. Testing associated with the subject invention indicates that non-problematic fluctuation appears to be concentrated at frequencies lower than approximately 1E-3 Hz (corresponding to a fluctuation period of 17 minutes) when caused by the gradually changing solar angle-of-incidence, or at frequencies higher than approximately 1E-1 Hz (corresponding to a fluctuation period of 10 seconds) when caused by obscuration of the moving solar disc by terrain or buildings. Conversely, substantial spectral content between those approximate frequencies represents problematic fluctuation caused by moving clouds.

### 9.3.3.1 Spectral Characteristics of Fluctuation Due to Moving Clouds

Because irradiance fluctuation has significant implications for the planning and design of solar power installations, the moving-cloud fluctuation spectrum has been studied extensively in the field of solar energy; see, for example Anvari et al (2016) and Olama et al (2020).

This research indicates three facts about the spectrum of fluctuation due to moving clouds:
a. The moving-cloud fluctuation spectrum is broader than the above-defined spectrum of problematic fluctuation; the moving-cloud fluctuation spectrum ranges from approximately 1E-4 Hz to 1 Hz.
b. When observed over at least several days, the moving-cloud fluctuation spectrum has the shape of a Kolmogorov turbulence spectrum, in which the Power-Spectral Density (PSD) is proportional to a power (exponent) of the frequency. The portion of this spectrum which represents problematic fluctuation (i.e. frequencies between approximately 1E-3 to 1E-1 Hz) appears to be within the so-called Kolmogorov inertial range, in which the power-law exponent is equal to approximately −5/3. Above 1E-1 Hz the shape is consistent with the Kolmogorov dissipative range, in which the negative exponent has a larger magnitude (i.e. the PSD begins to fall off more steeply with increasing frequency).
c. However, the moving-cloud fluctuation spectrum cannot be assumed to adhere closely to this Kolmogorov shape when observed over intervals shorter than several days. The shape of the short-term spectrum changes with time, so that a spectrogram (frequency-versus-time plot) is necessary to fully characterize the short-term fluctuation due to moving clouds.

Nevertheless, testing associated with the subject invention suggests that the short-term spectrum of fluctuation due to moving clouds does resemble a Kolmogorov spectrum sufficiently well to facilitate discrimination between problematic and non-problematic fluctuation. This fact is exploited by the subject invention.

### 9.3.3.2 Fluctuation Detection Based on Spectral Discrimination

Assuming that problematic fluctuation is caused only by moving clouds, and under conditions when the assumption of a Kolmogorov spectrum for moving-cloud fluctuation is valid, the presence of problematic fluctuation can be reliably inferred on the basis of the Power Spectral Density (PSD) in an irradiance signal at any frequency between approximately 1E-3 and 1E-1 Hz. Since the minimum time needed to sense the PSD at a given frequency is approximately equal to the reciprocal of that frequency, the fluctuation detection can be made in approximately 10 seconds at 1E-1 Hz, but would take 1000 seconds at 1E-3 Hz. The former is ostensibly preferable since it is desirable to make the fluctuation detection as quickly as possible.

On the other hand, because the short-term fluctuation spectrum does not necessarily resemble a Kolmogorov turbulence spectrum at every instant in time, the absence of a significant PSD at 1E-1 Hz over a 10-second observation interval does not guarantee the absence of problematic fluctuation at lower frequencies. For example, there can be repeated short intervals of high PSD at 1E-1 Hz, interspersed with several minutes of low PSD at 1E-1 Hz. Then, if the fluctuation detection is based solely on the PSD at 1E-1 Hz, the fluctuation detector will issue the “fluctuation” signal intermittently every few minutes. This, in turn, would cause system 10 (when performing the steps of FIGS. 6 and 7) to make shade-opening adjustments at the excessively frequent rate of every few minutes.

Thus, there is a trade between the reliability of the fluctuation detection and the interval over which the detection is made. This is discussed further in the context of the exemplar embodiments described below.

### 9.3.4 FIG. 8: Fluctuation Detector 50 Using Broadband Amplitude Demodulation

Problematic fluctuation can be distinguished from non-problematic fluctuation on the basis of the fluctuation amplitude averaged over an interval, which in turn can be sensed with a broadband amplitude demodulator driven from a signal representing the daylight level. The amplitude of the broadband fluctuation will also include a component due to high-frequency non-problematic fluctuation, but because non-problematic fluctuation is short-lived, it will have relatively little power over the averaging interval.

FIG. 8 shows a flowchart of fluctuation detector 50 implemented using such an approach. While it could be implemented in hardware (in which case the flowchart of FIG. 8 can be interpreted as a hardware block diagram), it is preferably implemented via software operating steps executed by controller 12 of FIG. 1.

Detector 50 includes software operations to perform five conventional processing steps:
a. A conventional differentiator block 53 performs differentiation with respect to time of the signal on input 51 in order to pass (and optionally amplify) only the time-varying component thereof. The output of block 53 is positive for increases in the signal on input 51 and negative for decreases thereof, with the magnitude depending on the rate of increase or decrease (and the amount of amplification, if any). If input 51 were an analog input, block 53 could consist of a capacitor or an active differentiator; in the preferred embodiment, it consists of a software step to subtract the previous value of the signal on input 51 from the current value (with optional multiplication to provide gain).
b. A conventional rectifier block 54 performs full-wave rectification of the output of block 53, passing (and optionally amplifying) the magnitude of the latter output. If block 54 were implemented in analog hardware, it could consist of an active rectifier; in the preferred embodiment, block 54 is implemented as an absolute-value function (with optional multiplication) in a software step. Alternatively, with some increase in complexity, rectifier block 54 could be replaced by a conventional power-law detector to respond to the power, rather than rectified amplitude, of the output of differentiator block 53.
c. A conventional averager block 55 averages the output of rectifier block 54 over an averaging interval. If implemented in analog hardware, block 55 could consist of a low-pass filter. In the preferred embodiment, block 55 consists of software steps to implement a conventional moving-average filter over the desired averaging interval.
d. A conventional comparator block 56 asserts the “fluctuation” signal when the output of averager block 55 exceeds a threshold, and de-asserts the “fluctuation” signal when the output of averager block 55 drops below a threshold. If implemented in analog hardware, block 56 could be implemented as an analog comparator; in the preferred embodiment, it is implemented as software operations performing a conditional test.
e. An optional conventional pulse-stretcher block 57 produces an output pulse of at least a predetermined duration (i.e. the pulse interval) on an output 52 when triggered by an input. Pulse-stretcher block 57 is retriggerable, so that multiple triggers within the pulse interval result in a single continuous pulse on output 52. Thus, because pulse-stretcher block 57 is driven by the output of comparator block 56, it extends the duration of any “fluctuation” signal asserted by comparator block 56 to at least the pulse interval. If implemented in hardware, pulse-stretcher block 57 could be implemented as a conventional retriggerable monostable multivibrator, but in the preferred embodiment is implemented via software operations to provide the same functionality.

Differentiator block 53 acts as a high-pass filter, with maximum sensitivity at a frequency that corresponds to the sampling rate at the input of fluctuation detector 50 (which is determined by the pause interval in pause step 21 of FIG. 2). If the pause interval is short enough to enable system 10 to respond quickly to glare-inducing conditions (e.g. 1 second), then the frequency at which differentiator block 53 has maximum sensitivity will approach 1 Hz.

However, as previously described, problematic fluctuation is limited to frequencies between approximately 1E-3 and 1E-1 Hz, while non-problematic fluctuation can have significant power at frequencies as high as 1 Hz. The purpose of averager block 55 is to attenuate the effects of the high-frequency non-problematic fluctuation, which are short-lived isolated events and hence get averaged-out over the averaging interval.

Averager block 55 also determines the response time of fluctuation detector 50 to the onset of fluctuation: the longer the averaging interval window size (i.e. the product of the sampling rate and the number of samples in the moving-average), the longer the response time. Thus, the averaging interval represents a trade-off. If the averaging interval is too long, system 10 will make an excessive number of opposing shading adjustments before fluctuation detector 50 is able to assert the “fluctuation” signal. On the other hand, if the averaging interval is too short, then short-lived non-problematic fluctuation will not be sufficiently attenuated, resulting in an excessive rate of false positive assertions of the “fluctuation” signal.

The appropriate averaging interval will depend, in part, on the shade-opening response time implemented by system 10. Specifically, if the shade-opening response time is not deliberately increased (e.g. as previously described in reference to FIGS. 3, 4, and 5), then a relatively short averaging interval (e.g. less than 100 seconds, and perhaps as short as 10 seconds) appears necessary to limit the frequency of shading adjustments at the onset of problematic fluctuation.

As previously described, problematic fluctuation will not necessarily have a Kolmogorov spectrum over any given averaging interval. Specifically, there can be repeated intervals of high-frequency fluctuation (e.g. at 1E-1 Hz) interspersed with intervals of minute or two without fluctuation. Under these conditions, fluctuation detector 50 should ideally produce a continuous “fluctuation” signal. However, if the averaging interval is relatively short (e.g. only 10 seconds), comparator block 56 will issue the “fluctuation” signal intermittently every minute or two, which can cause system 10 to make excessively frequent shading adjustments. This is mitigated by optional pulse-stretcher block 57, which lengthens the duration of any “fluctuation” signal produced by comparator block 56 to at least the pulse interval. Since pulse-stretcher block 57 is retriggerable, the fluctuation signal will be asserted continuously when the pulse duration is equal to or greater than the interval between fluctuations.

The pulse duration is a trade-off: if it is too short, then the “fluctuation” signal might not be continuously asserted during sustained fluctuation, but if it is too long, then shade-opening adjustments will be unnecessarily delayed after the cessation of problematic fluctuation.

The averaging interval and pulse-stretcher pulse duration can be optimized empirically according to the information provided herein.

9.3.4.1 Modifications to Fluctuation Detector 50 for Use with Closed-Loop Irradiance Sensor

As described in reference to FIG. 6, input 51 of fluctuation detector 50 can be the same irradiance signal used as the basis for daylight control, i.e. it can be the output of daylight sensing means 11. Also, as described in reference to FIG. 1, sensing means 11 can be disposed to sense daylight admitted by shading device 13 to enable closed-loop daylight control.

In such a configuration, the irradiance signal on input 51 of fluctuation detector 50 will vary not only with changes in the outside daylight irradiance, but also with changes in the setting of the shading device. To prevent the latter changes from being incorrectly detected as daylight fluctuation, the software operations associated with differentiator block 53 should be suspended in the intra-adjustment state of system 10, i.e. during shading adjustments.

### 9.3.5 Alternative Implementations of Fluctuation Detector 50

Feasible implementations of a fluctuation detector according to the subject invention can span a range of performance and complexity. Detector 50 as described in reference to FIG. 8 is optimized for simplicity, and improved performance may be possible via more complex implementations, some of which are described below.

9.3.5.1 Fluctuation Detector with Tailored Frequency Response

Differentiator block 53 of FIG. 8 acts a high-pass filter whose sensitivity increases by 20 dB per decade with increasing frequency. On the other hand, problematic fluctuation (assuming a Kolmogorov spectrum) has a PSD which decreases by approximately 17 dB per decade with increasing frequency.

Further, assuming that pause interval in step 21 of FIG. 2 is short enough to enable system 10 to respond quickly to glare-inducing conditions, the output of differentiator block 53 will peak at a frequency at which the PSD of non-problematic fluctuation is greater than that of problematic fluctuation (e.g. 1 Hz).

Therefore, the performance of fluctuation detector 50 can be improved by replacing differentiator block 53 with a conventional filter which passes only frequencies lower than those of non-problematic fluctuation, but also blocks the DC (non-varying) component of the signal on input 51. Such a filter is thus a bandpass filter.

As previously stated, the spectrum of problematic fluctuation ranges from approximately 1E-3 to 1E-1 Hz, so a bandpass filter which spans this range (or a subset thereof) can be used for the detection. However, the lower-frequency limit of the passband represents a trade between the reliability of detecting problematic fluctuation and the time required to make the detection:
a. Detection reliability can be maximized with a filter response that exactly matches the expected fluctuation spectrum, i.e. a passband of 1E-3 Hz to 1E-1 Hz and a response that drops by 17 dB per decade with increasing frequency (consistent with the assumption of a Kolmogorov spectrum). However, since the fluctuation period at 1E-3 Hz is 17 minutes, taking full advantage of such a wide passband would result in an unacceptably long detection time.
b. The detection time can be reduced by raising the lower-frequency limit of the passband to something greater than 1E-3 Hz. Unfortunately, this reduces the width of the passband and hence the fluctuation power captured by the filter, which is exacerbated by the 17 dB per decade loss in PSD with increasing frequency (assuming a Kolmogorov fluctuation spectrum). The result is a significant decrease in the reliability of the fluctuation detection. However, testing indicates that high reliability can still be achieved with a lower-frequency limit of approximately 1E-2 Hz (i.e. via a decade-wide passband that ranges from 1E-2 Hz to 1E-1 Hz). Assuming a detection time of at least one fluctuation period at the lowest frequency of interest, this would result in a minimum delay of approximately 100 seconds in the issuance (or cessation) of the “fluctuation” signal.
c. It appears possible to narrow the passband still further while maintaining an acceptable reliability of detection. For example, an octave-wide passband extending from 5E-2 Hz to 1E-1 Hz decreases the minimum response time to approximately 20 seconds, while still offering reasonably reliable detection of problematic fluctuation.

Based on testing to date, it appears that useful embodiments of the subject can be realized with a lower-frequency passband limit between approximately 1E-2 and approximately 5E-2 Hz, with an upper-frequency passband limit of approximately 1E-1 Hz.

Exemplar approaches for implementing fluctuation detection with a tailored frequency response are described below.

9.3.5.2 FIG. 9: Fluctuation Detector Using Band-Limited Amplitude Demodulation with a Bandpass Filter

FIG. 9 shows a flowchart of a fluctuation detector, fluctuation detector 50B, with a bandpass response. While it is advantageously implemented via software operating steps executed by controller 12 of FIG. 1, it could also be implemented in hardware, in which case the flowchart of FIG. 9 can be interpreted as a hardware block diagram.

Detector 50B is a form of conventional band-limited amplitude demodulator, and includes three elements:
a. A conventional bandpass filter 81 band-limits the signal on input 51 (which, as previously described in reference to detector 50, will fluctuate in the presence of daylight fluctuation). Bandpass filter 81 has a passband that is chosen according to the previously-described criteria. If the signal on input 51 were an analog signal, filter 81 could be an analog filter, but in the preferred embodiment is a conventional digital filter implemented via software operations executed by controller 12 of FIG. 1.
b. A conventional detector 82 produces a signal that depends on the amplitude at the output of filter 81. This can be either in analog form, or (in the preferred embodiment) in the form of software operations executed by controller 12.
c. Comparator block 56 produces the “fluctuation” output signal when the output of detector 82 exceeds a threshold.

### 9.3.5.3 FIG. 10: Fluctuation Detector Using Band-Limited Amplitude Demodulation Via the Goertzel Algorithm

An advantageous way of implementing bandpass filter 81 and detector 82 of detector 50B as shown in FIG. 9 is via software operations to implement the Goertzel algorithm. An implementation of a fluctuation detector using such an approach is fluctuation detector 50C, shown in flowchart form in FIG. 10, which includes two elements:
a. A Goertzel block 83 includes software operations to implement a Goertzel algorithm. Well-known in the art of digital signal processing, a Goertzel algorithm (of which several variations are known) is a way of efficiently determining the magnitude, and optionally the phase, of a signal in a single frequency band of interest. Only the magnitude (or optionally magnitude squared) is required for detector 50C, which further simplifies the implementation of the algorithm. In the preferred embodiment, Goertzel block 83 produces only the magnitude squared.
b. The output of Goertzel block 83 feeds comparator block 56, which produces the “fluctuation” signal on output 52 when its input exceeds a threshold.

Given the relatively low frequencies of daylight fluctuation, fluctuation detector 50C can be implemented with even a low-cost microcontroller, and yet provides the same functionality (in this application) as the much more computationally-intensive Discrete Fourier Transform.

### 9.3.5.4 Multi-Spectral Fluctuation Detection

As an extension of the bandpass-filtering approaches described above, multiple bandpass filters, each tuned to a different frequency, could be used to sample the fluctuation PSD. These could be implemented via a buffer to store time-sampled daylight levels, along with software operations to transform those time-domain samples into frequency-domain samples via a conventional implementation of a Discrete-Fourier Transform (DFT), Walsh-Hadamard Transform (WHT), or a wavelet-based transform.

A conventional algorithm could then be used to make the fluctuation detection on the basis of the fluctuation powers in multiple frequency bands. For example, the detection could be made on the basis of the ratio of the power in a lower-frequency spectral band to the power in a higher-frequency spectral band.

### 9.3.5.5 Fluctuation Detection Via Spectrogram

Rather than making the detection based just on the power in one or more frequency bands, the detection could be made on the basis of the change in the shape of the spectrum over time, i.e. via a spectrogram of the fluctuation. Such an approach in known, for example, in the fields of speech recognition, and could be particularly advantageous when coupled with Machine Learning (ML) techniques (as described below).

### 9.3.5.6 Fluctuation Detection Based on Alternative Irradiance Signal

In the embodiments described above, the irradiance signal used as the input for fluctuation detection is the same signal used as the basis for daylight estimation. For example, in FIGS. 6 and 12, the input of fluctuation detector 50 is the same signal used as the input for peak detector 60 (FIG. 6) and dual-time-constant filter 30 (FIG. 12).

However, the signal used as the basis for the fluctuation detection need not be the same as that used for daylight estimation.

For example, if daylight-sensing means 11 is located on the inward-facing side of shading device 13 to enable closed-loop daylight control, then input 51 of fluctuation detector 50 could be connected to the output of an illuminance sensor located on the outward-facing side of shading device 13. Conversely, if daylight-sensing means 11 is located on the outward-facing side of shading device 13 to enable open-loop daylight control, then input 51 of fluctuation detector 50 could be connected to the output of an illuminance sensor located on the inward-facing side of shading device 13.

As another example, input 51 could be connected to the real-time power output signal of the inverter in a building-mounted solar power installation to detect daylight fluctuations on the basis of fluctuations in the photovoltaic power output.

### 9.3.6 Indirect Detection of Problematic Fluctuation

As previously stated, problematic fluctuation is due to intermittent shading by moving clouds. It can therefore be detected indirectly via weather information, or by sensing the presence of moving clouds through analysis of imagery from a sky-facing camera.

### 9.3.6.1 FIG. 11: Fluctuation Detector Using Weather Api

Real-time weather data to enable indirect detection of ongoing or imminent fluctuation can be obtained via an Application Programming Interface (API) to any one of several online weather services. FIG. 11 shows a functional block diagram of a fluctuation detector 50D using such a weather API and consisting of two elements:
a. A weather-service API 84 is a conventional application programming interface and means of connection to an online weather service.
b. A fluctuation-detection algorithm 85 is an algorithm for processing data obtained from API 84 to infer ongoing or imminent fluctuation.

Both API 84 and algorithm 85 involve software operations which could be executed by controller 12 of FIG. 1, or could alternatively be performed by another processor. In a preferred embodiment, fluctuation detector 50D is implemented via software operations executed on a server located remotely from the other elements of system 10 of FIG. 1. This is advantageous because it allows one instance of fluctuation detector 50D to serve many instances of system 10 which experience the same weather conditions (e.g. located in the same building or campus).

A variety of approaches are possible in implementing algorithm 85:
a. As previously stated, irradiance fluctuation has significant implications for the planning and design of solar power installations, and has therefore been studied extensively in the field of solar energy. Some of these studies have been aimed at predicting the statistics of the spatiotemporal fluctuation of the irradiance in a given geographic area on the basis of historical weather data for that area.
b. For example, Bright et al (2015) have shown that local irradiance fluctuation on a 1-minute scale can be reliably predicted using hourly weather data on cloud cover, surface wind speed, cloud height, and atmospheric pressure. Algorithm 85 could therefore consist of the steps necessary to evaluate the irradiance time-series data produced by the Bright irradiance model (or a similar model) according to the frequency-domain criteria for problematic fluctuation previously defined herein.
c. However, experiments in connection with development of the subject invention indicate that ongoing or imminent fluctuation can be inferred using a simpler model that requires fewer weather data. Specifically, it appears that a useful indication of problematic fluctuation may be possible via a simple function of just the cloud cover and surface wind speed.
d. Alternatively, algorithm 85 could be implemented as a Machine-Learned (ML) model trained to detect ongoing or imminent problematic fluctuation using the same weather variables used by the Bright model. This would likely yield the most reliable indirection detection of problematic fluctuation, but like all ML approaches would require a significant amount of data to train the model.

Fluctuation detector 50D is more complex than embodiments which perform direct detection of problematic fluctuation (such as fluctuation detectors 50, 50B, and 50C), and there are typically costs associated with API access to a standard weather service. However, unlike direct detection, this approach can predict the onset and cessation of problematic fluctuation. Further, the increased complexity and costs associated with access to a weather service can be mitigated by sharing once instance of fluctuation detector 50D among many proximal instances of system 10, as previously described.

9.3.6.2 Indirection Detection of Fluctuation Via Imagery from Sky-Facing Camera

Use of a sky-facing camera to monitor sky conditions (e.g. cloud cover) is well-known in the meteorological sciences. The presence of moving clouds can be detected using conventional image-processing techniques to compare successive image frames produced by such a camera, which could then indirectly indicate the presence of daylight fluctuation.

However, this approach ostensibly provides little advantage over direct detection of problematic fluctuation, and is also significantly more expensive unless a sky-facing camera is already present.

### 9.3.7 Fluctuation Detection Based on Multiple Sources of Information

Increased reliability in detection of problematic fluctuation is likely achievable by basing the fluctuation detection on more than one of the types of information described above. For example, fluctuation detector 50 could subsume the functional blocks of FIG. 8 while also including API 84 to obtain data from an online weather service. In such a system, the “fluctuation” signal could be issued on the basis of the output of comparator block 56 if the data from API 84 indicates partly cloudy conditions, but suppressed if the weather data indicates clear-sky or fully overcast conditions. This would allow system 10 to respond quickly to changes in the daylight level that are not due to problematic fluctuation (e.g. due to obscuration of the solar disc by terrain or buildings).

### 9.3.8 Fluctuation Detection Via Machine-Learned Model

As previously stated, an ML model could be advantageously used for indirect detection of problematic fluctuation on the basis of weather data. However, practitioners will appreciate that an ML model could also be used for direct detection of fluctuation, and the inputs to an ML-based fluctuation detector could include any and all of the signals or information described above. For example, an ML-based approach could be used to recognize patterns associated with problematic fluctuation in a spectrogram (frequency versus time plot) of the irradiance.

An ML-based approach could be particularly advantageous in a supervised-learning context, in which the system includes a user-system interface to allow an occupant to indicate either an excessive or an inadequate adjustment frequency to “teach” the ML model.

### 9.3.9 Advantages and Disadvantages of Alternative Implementations of Fluctuation Detector 50

Some of the alternative implementations of fluctuation detector 50 described above are potentially capable of greater reliability in the detection of problematic fluctuation than is the relatively simple implementation described in reference to FIG. 8. However, the implementation of FIG. 8 provides sufficiently reliable fluctuation detection for typical applications of system 10, and will typically be simpler and less expensive to implement than the alternatives. In particular, the software operations needed to implement fluctuation detector 50 as shown in FIG. 8 are within the capabilities of even a simple 8-bit microcontroller.

However, if a more capable processing device is present for other reasons, or if the associated software operations are off-loaded to a remote (e.g. cloud-based) server, then one of the more sophisticated fluctuation detection approaches described above could be implemented without any additional hardware overhead and would therefore be preferable.

### 9.4 Advantages and Limitations of Inhibiting Shade Opening in Daylight Fluctuation

Use of fluctuation detection (e.g. via fluctuation detector 50 of FIG. 8) to inhibit shade opening (e.g. indirectly by inhibiting decrease in a daylight signal, as shown in FIG. 6, or directly as shown in FIG. 7), enables system 10 of FIG. 1 to respond quickly to isolated changes in the daylight level while avoiding distracting reversals of the direction of shading adjustments during problematic fluctuation of the daylight level. Testing shows that this behavior results in substantially greater occupant satisfaction than just increasing the response time symmetrically per conventional approaches.

However, there is necessarily a delay between the onset of problematic fluctuation and assertion of the “fluctuation” signal, during which time there can be an undesirably high frequency of opposing shading adjustments. There is also a delay between cessation of problematic fluctuation and de-assertion of the “fluctuation” signal, which unnecessarily delays shade opening when there is no risk of glare.

This delay can be minimized via the previously-described techniques, but this also reduces the reliability of the fluctuation detection (and increases the rate of false “fluctuation” signals when there is no problematic fluctuation). This dilemma can be mitigated by coupling an asymmetric response time (as previously described in reference to FIGS. 3, 4, and 5) with inhibition of shade-opening adjustments in daylight fluctuation.

### 10 Preferred Embodiments with Asymmetric Response Time and Inhibition of Shade Opening in Daylight Fluctuation

As described above, an asymmetric response time (e.g. as described in reference to FIGS. 3, 4, and 5) and inhibition of shade opening in daylight fluctuation (e.g. as described in reference to FIGS. 6 and 7) are each individually advantageous over the prior art, but are also complementary and thus even more advantageous when employed together.

Specifically, the longer shade-opening response time can be used to limit the shading adjustment frequency during the onset of fluctuation, before the fluctuation detector is able to issue the “fluctuation” signal. This, in turn, allows the use of a shorter shade-opening response time than would be possible without the fluctuation detector, and/or shorter averaging and pulse-stretcher intervals in the fluctuation detector than would be possible without the asymmetric response time. This can maximize responsiveness to non-problematic fluctuation without increasing the risk of distracting operation during problematic fluctuation. Various embodiments of such a system are possible and potentially advantageous.

10.1 FIG. 12: Preferred Embodiment with Asymmetric Response Time and Indirect Inhibition of Shade Opening in Daylight Fluctuation

Daylight estimation step 22 of FIG. 2 can be modified to provide system 10 of FIG. 1 with an asymmetric response time in addition to the capability to indirectly inhibit shade-opening adjustments in daylight fluctuation. FIG. 12 shows a flowchart of such a modified estimation step, an estimation step 22D. It is equivalent to step 22C of FIG. 6, except that dual-time-constant filter 30 of FIG. 3 is inserted between the output of daylight sensing means 11 of FIG. 1 and input 61 of peak detector 60.

Therefore, the output of step 22D will represent the daylight level smoothed with an asymmetric response time when there is no daylight fluctuation (as sensed by detector 50), but will represent the peak daylight level when there is daylight fluctuation. Thus, when system 10 of FIG. 1 performs step 22D instead of step 22 of FIG. 2, it will have an asymmetric response time to changes in the daylight level when there is no sustained daylight fluctuation, but will only close (and not open) shading device 13 during daylight fluctuation.

10.2 FIG. 13: Preferred Embodiment with Asymmetric Response Time and Direct Inhibition of Shade Opening in Daylight Fluctuation

The software steps of FIG. 2 can be modified to provide system 10 of FIG. 1 with an asymmetric response time in addition to the capability to directly inhibit shade-opening adjustments in daylight fluctuation. FIG. 13 shows how this can be done by inserting previously-described decision steps 41, 42, 43, and 72 between decision step 24 and command step 25 of FIG. 2:
a. If decision step 24 determines that the criteria for a shading adjustment have been met, then operation branches in step 41 depending on the direction of the required shading adjustment.
b. If the required adjustment is to close the shading, step 42 is performed which checks to ensure that the shade-closing criteria are continuously met for time T1. If this is the case, operation proceeds to command step 25 to close the shading; otherwise, operation proceeds to pause step 21 of FIG. 2.
c. On the other hand, if the required adjustment is to open the shading, operation proceeds from step 41 to step 72, which checks for the presence of fluctuation by checking whether the “fluctuation” signal is being asserted by fluctuation detector 50 (not shown in FIG. 13). If there is fluctuation, operation branches to pause step 21 of FIG. 2; otherwise, operation branches to command step 25, which issues a command to close the shading.

Thus, when system 10 of FIG. 1 performs the steps shown in FIG. 13 in addition to those shown in FIG. 2, it will have an asymmetric response time to changes when there is no sustained daylight fluctuation, but will only close (and not open) shading device 13 during daylight fluctuation.

10.3 Advantages of Asymmetric Response Time with Inhibition of Shade Opening in Daylight Fluctuation

The combination of an asymmetric response time and inhibition of shade-opening adjustments in daylight fluctuation is more advantageous than each applied individually, at only a small increase in complexity. Specifically, it can provide a shorter response to isolated changes in the daylight level without a significant increase in the frequency of distracting shading adjustments.

### 11 Preferred Embodiment with Shade-Opening Response Time Adjusted to Maximize Battery Life

As previously described, the frequency of shading adjustments made by a responsive daylight-control system can be minimized, while still preserving the benefits of responsive daylight control, by increasing the shade-opening response time. In addition to maximizing occupant satisfaction, this can also maximize battery life in battery-powered automated-shading systems. The subject invention can provide the latter benefit in at least three ways:
a. In a system which is capable of being powered by either battery power or mains-supplied power, the shade-opening response time can be automatically selected on the basis of the type of power source. Specifically, a longer shade-opening response time can be selected when under battery power than when under mains power.
b. In a battery-powered system, the shade-opening response time can be automatically selected on the basis of the presence or on/off state of a power-consuming peripheral such as a RF transceiver. Specifically, a longer shade-opening time-constant can be selected if an RF transceiver is present and enabled.
c. In a battery-powered system, the shade-opening response time can be increased with decreases in the remaining battery charge (e.g. as inferred by the battery voltage or a coulomb-counting device).

All three of the above can be employed simultaneously.

11.1 Preferred Embodiment with Shade-Opening Response Time Based on Power Source

Embodiments of the subject invention which implement asymmetric response times (such as those previously described in reference to FIGS. 3, 4, 5, 12, and 13) can be modified to make the shade-opening response time contingent on the type of power source. This is useful in a responsive daylight-control system which, at the discretion of the user, can be powered by a battery (in which case a relatively long shade-opening response time may be preferable to preserve battery life), or by mains power (in which case a relatively short shade-opening response time may be preferable to maximize responsiveness to falling daylight levels).

11.1.1 FIG. 14: Block Diagram of Responsive Daylight-Control System with Configurable Power Source

FIG. 14 shows a block diagram of a responsive daylight-control system 10B which can be powered by either battery power or mains-derived power. It is similar to system 10 of FIG. 1 except for the addition of a configurable power source 90 and the replacement of controller 12 with a controller 12B:
a. Configurable power source 90 is a conventional power supply capable of accepting power from either a battery or a mains supply, and providing that power to other elements. In the preferred embodiment, power source 90 includes a battery supply (including a battery holder and battery contacts to secure and accept power from a battery), and a coaxial (barrel) jack to accept DC power from a mains-powered source such as an AC-to-DC converter. Per conventional practice, the battery supply and coaxial power jack are connected in parallel in an electrical OR configuration so that both can supply power to controller 12B, with a MOS transistor used to isolate the battery supply from the mains-derived DC power.
b. Controller 12B is similar to controller 12, except that it includes conventional means of sensing the presence of a battery in source 90. In the preferred embodiment, this consists of an Analog-to-Digital Converter (ADC) input which senses the voltage on the battery-side of the MOS isolation transistor; a non-zero voltage at this point indicates the presence of a battery. Controller 12B also includes conventional means of passing power (e.g. a power bus) from source 90 to shading device 13 and optionally sensing means 11.

Thus, system 10B can be powered by either battery power or mains power at the discretion of the user, and controller 12B can detect the use of battery power by sensing the battery voltage via an ADC input.

### 11.1.2 Software Operations Performed by Controller 12B

Controller 12B of system 10B executes the software operations previously described for controller 12 of system 10 when the latter is implementing asymmetric response times. Specifically, controller 12B executes the software operations shown in FIG. 2, modified to either:
a. perform step 22B of FIG. 4 instead of step 22 of FIG. 2 (to implement asymmetric response times via the daylight signal chain), or
b. perform steps 41-43 of FIG. 5 in addition to the steps of FIG. 2 (to implement asymmetric response times via shading control logic).

These software operations, as performed by controller 12B, are further modified in two ways.

First, the shade-opening response time is an adjustable parameter rather than a constant. Specifically,
a. if asymmetric response times are implemented in the daylight signal-chain, then the time-constant of low-pass filtering step 33 (FIG. 3) of dual-time-constant low-pass filter 30 (FIGS. 3, 4, and 12) is an adjustable parameter; or
b. if asymmetric response times are implemented in the shading-control logic, then interval T2 of decision step 43 (FIGS. 5 and 13), is an adjustable parameter.

Second, as shown in FIG. 15, three software steps are added to enable controller 12B to establish the shade-opening response time based on the type of power being supplied by source 90:
a. In a decision step 91, controller 12B branches operation to one of two paths depending on the type of power source. As previously described, controller 12B determines the type of power source by sensing the voltage at the output of the battery supply portion of source 90. If the voltage is zero, then mains power is inferred and operation branches to an assignment step 92; if the voltage is non-zero, then battery power is inferred and operation branches to an assignment step 93.
b. In assignment step 92 and assignment step 93, the shade-opening response time is set to T2 and T3, respectively, with T3 being longer than T2. For example, T2 could be two minutes and T3 could be six minutes.

The software operations of FIG. 15 can be added to those shown in FIG. 2 so that they are performed periodically while the system is operating. Alternatively, they can be performed instead as part of an initialization sequence executed whenever power is applied to controller 12B; this is the approach used in the preferred embodiment.

Thus, system 10B will implement a shade-opening response time of T2 when operating under mains power, and a shade-opening response time of T3 when operating under battery power.

This approach could be extended to make the shade-opening time-constant contingent on aspects of the system configuration other than the power source, e.g. the presence of power-consuming peripherals such as a Wi-Fi transceiver. For example, assignment step 93 could be replaced with another decision step to determine whether a Wi-Fi transceiver is present and enabled, and if so, to increase the shade-opening time-constant still further to help extend battery life.

11.2 Preferred Embodiment with Shade-Opening Response Time Based on Remaining Battery Charge

Embodiments of the subject invention which implement asymmetric response times (such as those previously described in reference to FIGS. 3, 4, 5, 12, 13, 14, and 15), and which are battery-powered, can be modified to make the shade-opening response time contingent on the remaining battery charge.

11.2.1 FIG. 16: Block Diagram of Responsive Daylight-Control System with Battery Power Supply

FIG. 16 shows a block diagram of a responsive daylight-control system 10C which is battery powered and which is capable of automatically varying the shade-opening response time with the remaining battery charge. It is similar to system 10 of FIG. 1 except for the addition of a battery power supply 94 and the replacement of controller 12 with a controller 12C:
a. Battery power supply 94 is a conventional battery power supply that is capable of storing a charge to power system 10C via a primary battery, a mains-rechargeable secondary battery, a solar-charged secondary battery, a secondary battery augmented with a supercapacitor or ultra-capacitor, or some other energy-storage device.
b. Controller 12C is similar to controller 12, except that it includes conventional means of sensing the charge remaining in battery supply 94. In the preferred embodiment, this is implemented by a conventional “coulomb-counter” integrated circuit (sometimes called a “battery fuel gauge”). Controller 12C also includes conventional means of passing power (e.g. a power bus) from supply 94 shading device 13 and optionally sensing means 11.

Thus, system 10C is battery-powered and controller 12B can sense the remaining battery charge.

### 11.2.2 Software Operations Performed by Controller 12C

Controller 12C of system 10C executes the software operations previously described for controller 12 of system 10 when the latter is implementing asymmetric response times. Specifically, controller 12C executes the software operations shown in FIG. 2, modified to either:
a. perform step 22B of FIG. 4 instead of step 22 of FIG. 2 (to implement asymmetric response times via the daylight signal chain), or
b. perform steps 41-43 of FIG. 5 in addition to the steps of FIG. 2 (to implement asymmetric response times via shading control logic).

These software operations, as performed by controller 12C, are further modified in two ways.

First, the shade-opening response time is an adjustable parameter rather than a constant. Specifically,
a. if asymmetric response times are implemented in the daylight signal-chain, then the time-constant of low-pass filtering step 33 (FIG. 3) of dual-time-constant low-pass filter 30 (FIGS. 3, 4, and 12) is an adjustable parameter; or
b. if asymmetric response times are implemented in the shading-control logic, then interval T2 of decision step 43 (FIGS. 5 and 13), is an adjustable parameter.

Second, as shown in FIG. 17, three software steps are added to those of FIG. 2 to enable controller 12C to vary the shade-opening response time based on remaining state of charge of battery power supply 94:
a. In a step 95, controller 12C senses the remaining battery charge and compares it to a threshold. If the charge is above the threshold, the battery state is deemed “ok” and operation branches to an assignment step 96. Otherwise, if the charge is below the threshold, the battery state is deemed “low” and operation branches to an assignment step 97.
b. In assignment steps 96 and 97, the shade-opening response time is set to T3 and T4, respectively, with T4 being longer than T3. For example, T3 could be six minutes and T4 could be fifteen minutes.

Thus, system 10 will implement a shade-opening response time of T3 when the battery charge is nominal, and a shade-opening response time of T4 when the battery charge is low.

11.3 Preferred Embodiment with Shade-Opening Response Time Varying as an Arbitrary Function of Remaining Battery Charge

When system 10C of FIG. 16 performs the additional software operations shown in FIG. 17, it implements one of two shade-opening response times as a function of the remaining battery charge. Alternatively, it could implement a response time which is as arbitrary function of the remaining charge. This would be achieved by replacing steps 95, 96, and 97 of FIG. 17 with steps to:
a. sense the remaining charge, and
b. calculate a value of the shade-opening response time as a function of that value.

A variety of potentially useful functions are possible. For example, the shade-opening response time could increase continuously and linearly with decreasing battery charge.

Alternatively, it could increase continuously until the battery charge drops to a predetermined value, at which point the shade-opening response time could be set to a very large value to completely inhibit shade-opening adjustments until the battery is charged or replaced. This would preserve glare-blocking capability (by allowing shade-closing adjustments) while also providing a clear indication of the need to charge or replace the battery.

A function in which the shade-opening response time increases continuously with decreasing battery charge is particularly advantageous when the battery supply 94 includes a solar-charged battery, because it enables system 10C to automatically optimize the shade-opening response time based on the average power output of the photovoltaic source.

### 11.4 Advantages of Shade-Opening Response Time Adjusted to Maximize Battery Life

The embodiments described in reference to FIGS. 14-17 can extend battery life in battery-powered responsive daylight-control systems without sacrificing responsiveness in blocking daylight glare. The increase in battery life is particularly significant in systems in which the power consumed in shading adjustments is a significant fraction of the overall power consumption. Such systems include those which do not have wireless connectivity (which often dominates the overall power consumption), or those in which a low-power protocol (such as Zigbee/Thread or BLE) is used for wireless connectivity.

### 12 Preferred Embodiment with Slow-Response Shade-Opening in Sustained Daylight Fluctuation

The embodiments of responsive daylight control system 10 described in reference to FIGS. 6-13 completely inhibit shade opening adjustments in the presence of sustained daylight fluctuation.

However, while this eliminates the risk of frequent shading adjustments during sustained fluctuation, it also causes the shading to remain excessively closed even while the average irradiance drops significantly as the sun descends toward the horizon.

This effect can be mitigated by enabling shade-opening adjustments in the presence of sustained daylight fluctuation—but with a much longer response time than when there is no sustained fluctuation. System 10 of FIG. 1 can implement such a capability through modification of estimation step 22 of FIG. 2.

FIG. 18 is a logic diagram of such a modified estimation step, an estimation step 22E, which is implemented in software steps executed by controller 12 of FIG. 1. Step 22E subsumes step 22 of FIG. 2, preceding it by three functional blocks: fluctuation detector 50 (previously described in reference to FIG. 8), a time-constant logic block 101, and a Low-Pass Filter (LPF) 102.

LPF 101 is a conventional parameterized low-pass filter. It low-pass filters the output of daylight sensing means 11 of FIG. 1 (as sampled after pause step 21 of FIG. 2) with a time-constant which is determined by a time-constant parameter. In the preferred embodiment, LPF 101 is implemented as a conventional Exponentially Weighted Moving-Average (EWMA) filter, with the effective time constant set by an EWMA weighting parameter. The output of LPF 101 drives daylight-estimation step 22 previously described in reference to FIG. 2.

Time-constant logic block 102 determines the value of the time-constant parameter of LPF 101 as a function of the output of fluctuation detector 50 and the output of daylight sensing means 11 of FIG. 1. FIG. 19 is a flowchart of steps performed in time-constant logic block 102:
a. In a decision step 103, operation branches depending on whether there has been a change in the daylight level, and if so, depending on the sign of the change. If there is no change, no other steps are performed in block 102. If there has been a positive change (i.e. the daylight level has increased), an assignment step 105 is performed in which a time constant parameter T is set to a value TA. However, if there has been a negative change, operation branches to a decision step 104.
b. In decision step 104, operation branches depending on the presence of fluctuation (i.e. as indicated by the output of fluctuation detector 50 of FIG. 17). If there is no fluctuation, an assignment step 106 is performed in which T is set to TB, but if there is fluctuation, an assignment step 107 is performed in which T is set to TC.

Thus, daylight-estimation step 22E provides a low-pass-filtered estimate of the daylight level, such that there is a low-pass filtering time constant of TA for increases in daylight, a time-constant of TB for decreases in daylight when there is no fluctuation, and a time-constant of TC for decreases in daylight when there is fluctuation.

Because TA determines the response time for shade-closing adjustments, it is analogous to the time-constant of LPF 1 of FIG. 3 and to interval T1 of FIG. 5. As previously described for LPF 1 and interval T1, TA should be no longer than several seconds in order to enable system 10 to close the shading quickly to block daylight glare.

Because TB determines the response time for shade-opening adjustments when there is no sustained fluctuation, it is analogous to the shade-opening time-constants of the embodiments previously described in reference to FIGS. 12 and 13. TB should be long enough to limit the frequency of shading adjustments when the fluctuation level is too low to be detected by fluctuation detector 50, but not so long as to cause an excessive delay in opening the shading in response to falling daylight levels. A value of several minutes has proven effective for TB.

Time-constant TC determines the response time for shade-opening adjustments during sustained fluctuation. TC should be as long as possible while still allowing the output of LPF 101 to track the relatively slow decreases in peak irradiance due to movement of the sun as it descends from maximum elevation toward the horizon. To date, values of approximately 15 to 120 minutes have proven effective for TC.

12.1 Alternative Embodiment with TB Contingent on Type of Power Source and/or Remaining Battery

### Charge

While a fixed value (e.g. a few minutes) can be used for TB as described above, it is also potentially advantageous to make TB contingent on the type of power source and/or the remaining battery charge, as previously described for the embodiments of FIGS. 14 through 17. In this case, TB could be set to either T2 or T3 of FIG. 15 depending on the type of power source, or either T3 or T4 of FIG. 17 depending on the level of remaining charge, as described for the corresponding embodiments.

### 12.2 Alternative Embodiments of Fluctuation Detector 50

As previously described in reference to FIG. 8, fluctuation detector 50 uses full-wave rectification to sense the fluctuation power. This maximizes sensitivity to fluctuation, but causes the fluctuation signal to be falsely asserted when the irradiance drops at sunset, unnecessarily delaying shade opening. This can be avoided by using half-wave rectification to detect only increases in the daylight level.

Alternatively, any of the other fluctuation detector embodiments described herein (such as those of FIGS. 9-11) could be used instead of fluctuation detector 50.

### 12.3 Advantages of Enabling Slow-Response Shade Opening in Sustained Fluctuation

When system 10 of FIG. 1 is modified as described in reference to FIGS. 18 and 19, it allows the shading to open during sustained fluctuation, but the increased shade-opening response time causes the shading to open only in response to the slow, non-problematic fluctuation associated with changes in the solar elevation angle. It thereby avoids the over-shading that would otherwise occur if shade opening were completely inhibited during problematic fluctuation in the afternoon, while still avoiding excessively frequent shading adjustments.

### 13 Preferred Embodiment of Fluctuation Detector with Reduced Release Time after Isolated Fluctuations

The purpose of the fluctuation detectors described herein is to continuously assert a fluctuation signal during sustained problematic fluctuation due to moving clouds, and ideally only during such fluctuation. In fluctuation detector 50 of FIG. 8, this is accomplished by optimizing the averaging interval of averager block 55, and optionally including pulse stretcher 57 to extend the duration of the signal as necessary.

However, because fluctuation detector 50 employs broadband amplitude demodulation (via rectification of the daylight signal), any change in the daylight irradiance—not just during sustained fluctuation due to moving clouds, but also due to movement of the sun—will contribute to the fluctuation energy accumulated in averager block 55. If the irradiance then falls, the accumulated fluctuation energy will cause fluctuation detector 50 to continue to assert the fluctuation signal for an interval referred to herein as the release time, thereby delaying shade opening.

While an extended release time is desirable during sustained problematic fluctuation, it is undesirable during isolated fluctuations. Isolated fluctuations occur, for example, when the rising sun is obscured by buildings, or when the moving sun emerges from behind a building and is then obscured by other buildings. Ideally, the shading would be opened quickly after such isolated fluctuations, but due to the release time necessary to span problematic fluctuations, fluctuation detector 50 will continue to assert the fluctuation signal for an unnecessarily long interval after the irradiance falls, excessively delaying shade opening.

This can be mitigated by basing the fluctuation signal on only the positive fluctuation (i.e. increases in the daylight level) as low-pass filtered with a time-constant (or averaged over an interval) which depends on the amount of negative fluctuation (i.e. decreases in the daylight level). This enables a suitably long release time during sustained fluctuations (ensuring that the fluctuation signal remains asserted continuously), but a suitably short release time during isolated fluctuations (ensuring that the fluctuation signal is de-asserted quickly after the daylight level falls).

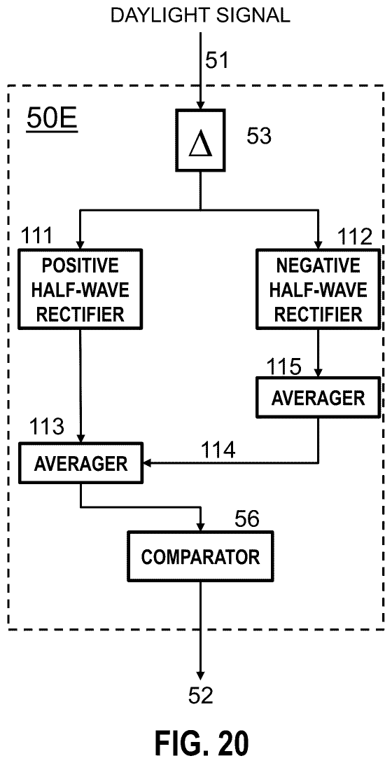

Such a fluctuation detector could be implemented in hardware, but (as with fluctuation detector 50) is preferably implemented via software operations executed by controller 12 of FIG. 1. FIG. 20 is a flowchart to implement a preferred embodiment of such a fluctuation detector 50E, which includes the following functional blocks:
a. Differentiator block 53 (previously described in reference to FIG. 8) performs differentiation with respect to time of the signal on input 51 in order to pass only the time-varying component thereof. Thus, the output of block 53 is positive for increases in the signal on input 51 and negative for decreases thereof, with the magnitude depending on the rate of increase or decrease.
b. A positive half-wave rectifier 111 and a negative half-wave rectifier 112 perform half-wave rectification of the output of block 53: rectifier 111 passes only positive outputs of block 53 as positive signals, while rectifier 112 passes only negative outputs of block 53 as positive signals). Thus, rectifiers 111 and 112 detect the positive and negative amplitudes, respectively, of the fluctuation. Rectifiers 111 and 112 can be implemented, for example, via conditional mathematical operators (and a sign change to invert the output of rectifier 112). Rectifier 111 feeds an averager 113, while rectifier 112 feeds an averager 115.
c. Averager 113 averages the output of rectifier 111 over a first averaging interval which depends on a signal 114. Averager 113 can be conveniently implemented, for example, as a conventional first-order Exponentially Weighted Moving Average (EWMA) filter, with a single weighting parameter which varies with signal 114. The relationship between signal 114 and the first averaging interval can be linear or non-linear as required to achieve the desired behavior described below; a linear relationship has worked well in prototypes of detector 50E.
d. Signal 114 is the output of averager 115, which averages the output of negative half-wave rectifier 112 over a second averaging interval. Averager 115 can be implemented in the same way as averager 113, although it does not require a variable averaging interval.
e. Comparator block 56 (previously described in reference to FIG. 8) asserts the “fluctuation” signal when the output of averager 113 exceeds a threshold, and de-asserts the “fluctuation” signal when the output of averager 113 drops below a threshold.

Thus, fluctuation detector 50E functions in much the same way as fluctuation detector 50 of FIG. 8, with positive half-wave rectifier 111 being analogous to full-wave rectifier block 54 and averager 113 being analogous to averager block 55. However, instead of using a fixed averaging interval (as is the case with averager block 55 of detector 50), averager 113 has a variable averaging interval which depends on the average negative fluctuation as sensed by rectifier 112 and averager 115. Thus, the positive fluctuation is low-pass filtered with a relatively long time-constant when there is substantial average negative fluctuation (e.g. during sustained fluctuation), but with a relatively short time-constant when there is little average negative fluctuation (e.g. while the irradiance is rising slowly prior to an isolated fluctuation event).

The averaging interval of averger 115, and the relationship between the output of averager 115 (i.e. signal 114) and the variable averaging interval of averager 113, should be chosen to yield the following behavior:
a. During problematic fluctuation with repeated significant decreases in the daylight level, the variable averaging interval of averager 113 should be long enough (e.g. 10 minutes) to ensure that the fluctuation signal produced by comparator 56 remains asserted continuously.
b. After a single isolated decrease in the daylight level, the variable averaging interval of averager 113 should be short enough (e.g. 1 minute) to provide an acceptably short delay in de-asserting the fluctuation signal.

Fluctuation detector 50E can be used instead of, and in the same way as, any of fluctuation detectors 50 and 50B-50D of the previously-described embodiments of the subject invention.

13.1 Advantages of Reduced Release Time after Isolated Fluctuations

Isolated fluctuations in the daylight level occur much less frequently than sustained fluctuations. However, when they do occur, any delay in shade-opening adjustments following a decrease in irradiance is quite noticeable to building occupants. Therefore, the reduced release time after isolated fluctuations enabled by fluctuation detector 50E should significantly increase occupant satisfaction with responsive daylight control, and testing to date has confirmed this.

### 13.2 Alternative Embodiments of Fluctuation Detector 50E

A wide range of alternative embodiments of fluctuation detector 50E are possible while still retaining the key principle of fluctuation detection based on positive fluctuation which is averaged over an interval which depends on negative fluctuation.

As with any device, the implementation of fluctuation detector 50E represents a trade between ease of implementation and performance (i.e. sensitivity to problematic fluctuation and insensitivity to non-problematic fluctuation). The above-described embodiment is intended to maximize ease of implementation while still providing good performance, but a more complex embodiment could provide still better performance.

For example, rectifiers 111 and 112 are implemented using simple conditional operators (and a sign inversion in the case of rectifier 112), so their outputs vary with the amplitudes of the positive and negative fluctuations (respectively). Increased reliability of fluctuation detection might be possible if rectifiers 111 and 112 were modified to have a non-linear response to fluctuation amplitude (such as a square-law response to directly sense the fluctuation power, or a logarithmic response to provide greater dynamic range).

As another example, differentiator block 53 is simple form of first-order high-pass filter, while averagers 113 and 115 are simple forms of first-order low-pass filter. A higher-order high-pass filter, and/or a high-pass filter of another form, could be used instead of differentiator block 53 and might enable increased performance. Similarly, a higher-order low-pass filter, and/or a low-pass filter of another form (such as a lossy integrator), could be used instead of either or both of averagers 113 and 115 and might enable increased performance. However, the broadband spectral characteristics of problematic fluctuation suggest that any benefit of more complex filters would be modest.

As another example, fluctuation detector 50E of FIG. 20 could include a machine-learned model which performs all or some of the functions of the elements shown in FIG. 20.

### 14 Additional Implementation Considerations and Alternatives

14.1 Use with Devices Other than Motorized Horizontal Blinds

As previously stated, shading device 13 is advantageously a horizontal blind with a motorized slat-tilt function. Such motorized blinds are preferred for responsive daylight control applications due to their low cost, unobtrusive operation, and fine control of admitted daylight.

However, because the subject invention enables a reduction in the frequency of shading adjustments needed for responsive daylight control, it can also enable the use of shading devices which are more obtrusive in operation and provide coarser control of admitted daylight, such motorized curtains and shades.

Because such shading devices are more obtrusive in operation than motorized blinds, their use as shading device 13 will typically require a longer shade-opening response time (and potentially a longer shade-closing response time), and typically a larger deadband (e.g. as evaluated in decision step 24 of FIG. 2), than if a motorized horizontal blind were used.

### 14.2 Increasing the Shade-Closing Response Time in Addition to the Shade-Opening Response Time

According to the subject invention, increasing the shade-opening response time is preferable to increasing the shade-closing response time as a means of reducing the frequency of shading adjustments needed for responsive daylight control. This is because responsiveness to rising daylight levels (i.e. to quickly block daylight glare) is typically more important than responsiveness to falling daylight levels.

If there is little risk of daylight glare, however, it may be advantageous to increase the shade-closing response time in addition to increasing the shade-opening response-time. This can be the case, for example, with a shading device mounted on a window which never receives direct sunlight. In such cases, the embodiments of system 10 described above can be modified to increase the shade-closing response time in the same way as the shade-opening response time is increased.

### 14.3 Optimization of Parameter Values

The parameter values cited in this disclosure have proven to be workable in useful embodiments of the subject invention, but are not necessarily optimal. Practitioners can use the information provided herein to optimize the values for a given application, preferably empirically.

### 14.4 User-Selectable Parameter Values

In lieu of optimizing the parameter values prior to usage of a responsive daylight-control system according to the subject invention, the numerical values of the parameters could be made user-adjustable via a conventional user-system interface.

For example, a user interface could be provided to enable a user to explicitly specify the shade-opening and shade-closing response times, incrementally increase or decrease the response times, or indirectly specify the response times by selecting from a menu of predefined usage variables. In the latter case, the predefined usage variables could include the following:
a. Whether the window on which the shading device is mounted can receive direct sunlight. If the window cannot receive direct sunlight, then a longer shade-closing response time may be appropriate, since there is no risk of extremely high glare.
b. The type of shading device. If the shading device is a smart window, the optimum shade-opening response time will typically be shorter than for a motorized horizontal blind (per the previously-described embodiment of shading device 13). On the other hand, if the shading device is a roller shade, then the optimum shade-opening response time will be longer than for a motorized horizontal blind, and longer still if the shading device is a motorized curtain. The optimum shade-closing response time will also vary with the type of shading device, but to a lesser degree.
c. The power source. As previously described, a battery-powered system can benefit from a longer shade-opening response time to maximize battery life.

### 14.5 Distribution of Functions or Elements Among Separate Locations or Physical Devices

Referring again to FIG. 1, sensing means 11, controller 12, and shading device 13 need not necessarily be collocated, but could instead be in separate locations and interconnected by wired or wireless links. For example,
a. Controller 12 could be collocated with shading device 13, but sensing means 11 could be in a remote sensor assembly connected to controller 12 via a wireless protocol such as Zigbee or Thread.
b. When sensing means 11 is implemented as a remote sensor assembly as described above, then some of the functionality provided by controller 12 can advantageously be provided by a processor in the same remote sensor assembly. For example, the portion of controller 12 which performs steps related to estimating the daylight level (such as steps 21 and 22 of FIG. 2, step 22B of FIG. 4, step 22C of FIG. 6, or step 22D of FIG. 12) could be integrated in the same remote sensor assembly with sensing means 11. Thus, an existing responsive daylight-control system intended for use with a remote sensor assembly could be upgraded into an embodiment of the subject invention by simply replacing the conventional sensor assembly.
c. A portion (or all) of controller 12 could be “in the cloud”, i.e. implemented on a server connected to sensing means 11 and shading device 13 via the internet through a gateway.
d. A portion (or all) of controller 12 could be incorporated in a home-automation hub, voice-assistant, building-management system, desktop computer, or personal electronic device.

### 14.6 Implementation via Software-Only Modifications to Conventional System

As previously described in reference to FIG. 1, the hardware configuration of system 10 according to the subject invention is consistent with that of a conventional responsive daylight-control system. Thus, the subject invention could be implemented solely via modifications to the software (or firmware) of such a conventional system to implement the operating steps described herein.

### 15 Conclusions, Ramifications, and Scope

As this disclosure makes clear, the subject invention enables a responsive daylight control capability which responds quickly to the onset of glare-inducing conditions and reasonably quickly to the cessation of glare-inducing conditions, and yet which avoids excessively frequent shading adjustments (and especially closely-timed adjustments in opposite directions). The subject invention thus enables a capability which provides the benefits of conventional responsive daylight-control systems, but without the conventional systems' tendency to annoy building occupants and with reduced power consumption. In doing so, the subject invention eliminates a significant barrier to mainstream use of responsive daylight-control technology.

Those skilled in the art will recognize that the construction, function, and operation of the elements composing the preferred and alternative embodiments described herein may be modified, eliminated, or augmented to realize many other useful embodiments, without departing from the scope and spirit of the invention as disclosed herein and recited in any appended claims.

I claim:

1. A system for automatic control of daylight, said system including:
a. an electronically-actuated shading device;
b. daylight-sensing means for sensing a level of daylight; and
c. a controller configured to:
i. close said shading device after a first response time after an increase in said level of daylight; and
ii. open said shading device after a second response time after a decrease in said level of daylight, said second response time being greater than said first response time.

2. The system of claim 1 which further includes fluctuation-detecting means for detecting a fluctuation in said level of daylight, and wherein said controller is configured to increase said second response time when said fluctuation is detected.

3. The system of claim 2 wherein said fluctuation-detection means includes an amplitude demodulator.

4. The system of claim 2 wherein said fluctuation-detection means includes an application-programming interface to a source of weather data.

5. The system of claim 2 wherein said fluctuation-detection means includes:
a. first sensing means of sensing an increase in said level of daylight to produce a positive fluctuation signal;
b. second sensing means of sensing a decrease in said level of daylight to produce a negative fluctuation signal; and
c. filtering means of low-pass filtering said positive fluctuation signal with a time-constant which depends on said negative fluctuation signal.

6. The system of claim 1 which can be configured to accept power from a one of a plurality of power sources including a battery, and in which said controller is configured to increase said second response time when said system is configured to accept power from said battery.

7. The system of claim 1 which is configured to accept power from a battery and which further includes charge-sensing means for sensing a level of charge of said battery, and in which said controller is configured to increase said second response time with a decrease in said level of charge.

8. A system for automatic control of daylight, said system including:
a. an electronically-actuated shading device;
b. daylight-sensing means for sensing a level of daylight;
c. fluctuation-detection means for detecting a fluctuation of daylight;
d. a controller configured to:
i. perform an opening of said shading device following an decrease in said level of daylight;
ii. perform a closing of said shading device following an increase in said level of daylight; and
iii. inhibit said opening of said shading device when said fluctuation is detected.

9. The system of claim 8 wherein said fluctuation-detection means includes an amplitude demodulator.

10. The system of claim 8 wherein said fluctuation-detection means includes an application-programming interface to a source of weather data.

11. The system of claim 8 wherein said fluctuation-detection means includes:
a. first sensing means of sensing an increase in said level of daylight to produce a positive fluctuation signal;
b. second sensing means of sensing a decrease in said level of daylight to produce a negative fluctuation signal; and
c. filtering means of low-pass filtering said positive fluctuation signal with a time-constant which depends on said negative fluctuation signal.

12. A system for automatic control of daylight, said system including:
a. an electronically-actuated shading device;
b. daylight-sensing means for sensing a level of daylight;
c. a battery, said battery having a level of charge; and
d. a controller configured to actuate said shading device after a response time following a change in said level of daylight, wherein said response time depends on said level of charge of said battery.
